(19) United States
(12) Patent Application Publication
(10) Pub. No.: US 2015/0090252 A1
(43) Pub. Date: Apr. 2, 2015

(54) APPARATUS AND PROCESS FOR PASTEURIZATION OF SAP AND PRODUCT THEREOF

(71) Applicant: FEDERATION DES PRODUCTEURS ACERICOLES DU QUEBEC, Longueuil (CA)

(72) Inventors: Julie BARBEAU, Boucherville (CA); Genevieve BELAND, Saint-Hyacinthe (CA)

(73) Assignee: FEDERATION DES PRODUCTEURS ACERICOLES DU QUEBEC, Longueuil (CA)

(21) Appl. No.: 14/555,916

(22) Filed: Nov. 28, 2014

Related U.S. Application Data
(63) Continuation of application No. 14/004,586, filed on Sep. 11, 2013.
(60) Provisional application No. 61/593,985, filed on Feb. 2, 2012.
(60) Provisional application No. 61/591,604, filed on Jan. 27, 2012.
(60) Provisional application No. 61/453,270, filed on Mar. 16, 2011.

(51) Int. Cl. C13B 20/16; A23L 1/09; A23L 1/025; A23L 3/01; A23L 1/015

(52) U.S. Cl. CPC C13B 20/16; A23L 3/01; A23L 1/0151; A23L 1/025; A23L 1/09; C13B 20/165; A23V 2002/00
USPC 127/55

(57) ABSTRACT

The present document describes an apparatus, and processes for the sterilization and/or pasteurization of sap without denaturing polyphenols and other ingredients present therein, and a sap product prepared from the processes

### CROSS-REFERENCE TO RELATED APPLICATIONS

This application claims priority from U.S. provisional patent applications 61/453,270, filed Mar. 16, 2011, 61/591,604, filed Jan. 27, 2012; and 61/593,985, filed Feb. 2, 2012, the specifications of which are hereby incorporated by reference in their entirety.

### BACKGROUND

(a) Field

The subject matter disclosed generally relates to an apparatus and a process for the sterilization and/or pasteurization of sap or sap concentrate without denaturing the proteins and other ingredients present therein.

(b) Related Prior Art

To produce high quality maple syrup every effort must be made to maintain high quality sap that is relatively free of microorganisms from the tap hole to the evaporator.

Various species of bacteria, yeast, and mould may be found in maple sap or sap concentrate. Sap is an ideal growth medium for microorganisms because it contains sugars (largely sucrose), minerals, and amino acids suitable for microbial growth and reproduction.

Growing microbial populations have three effects on sap. Firstly, enzymes secreted by microorganisms break down sucrose into glucose and fructose, which causes a darkening in syrup colour and a caramel taste; secondly, microorganisms can cause off-flavour and thirdly, increase maple syrup viscosity. These effects are intensified as the temperature warms and microbial growth increases significantly.

There are a variety of methods to control or reduce microbial activity in maple sap or sap concentrate. They include sanitary tapping, keeping sap cool in the sugar bush and storage tanks, boiling sap soon after it runs, keeping buckets, gathering tanks and storage tanks properly covered to keep out debris, use of germicidal ultraviolet irradiation, cleaning and sanitizing equipment, and filtration of sap by various means.

All methods of food preservation that lead to killing of microorganisms (e.g. thermal processes), to physical extraction of microorganisms from the environment (e.g. mechanical processes), to stopping microorganisms growth by eliminating or modifying the parameters needed for growth (e.g. biological processes), to putting them into contact with harmful substances (e.g. chemical processes) or waves (e.g. ionic processes) or electrical impulses (e.g. electrical processes). The processes may be made to conform to the Good Manufacturing Pratices (GMP).

Filtration involves pouring or pumping sap through a filter or series of filters to remove suspended materials, including some of the microorganisms. Suspended material in sap may include small bits of bark and wood, dust or dirt, insects and any other debris that might fall into sap buckets or open storage tanks. It is important to remove this material from the sap by filtering as soon as possible since debris in sap can be a source of microbial contamination. Filtration of sap is accomplished by using gravity and/or pressure type filters at appropriate locations in the sap transfer system. The suspended material can also be accomplished by centrifugation of the sap or sap concentrate, using batch or continuous centrifugation system.

The major objective of filtering maple sap is to maintain and/or improve the quality of the sap and the maple products made from it. To date no scientific studies have been conducted to evaluate the extent of the improvement. However, maple producers have reported that filtering sap increases the quality of their maple syrup by as much as one full grade by improving the color class.

The activity of microorganisms influences the length of time sap can be stored. To increase the safe storage period for sap requires either complete sterilization of the sap (ultraviolet irradiation) or control of the microbial population by keeping it at a low level so that any biochemical changes due to microorganisms in the sap before processing are minimal. Maple sap filtration will not overcome spoilage caused by microbial activity occurring in sap collection system. However, if filtration is carried out properly and storage conditions are unfavorable for microbial growth, it will maintain the quality of sap during storage for a longer period of time.

Microorganisms in sap range in size from hundreds of microns to less than one micron. Organisms less than 40 microns cannot be seen without the aid of a microscope, while organisms smaller than 1 micron cannot be seen without the use of an electron microscope.

Microorganisms can grow rapidly when conditions are favorable and some species will even grow below freezing point. Growth of microorganisms normally refers to the growth of populations of cells, which is the increase in the number of cells not the growth of individual cells. Limiting and/or reducing the number of microorganisms in sap improves the quality of it and the syrup produced from it will be lighter in color.

The filtration of sap to remove microorganisms has been improved by developments in filtration and purification of water. Both small pore water filters and diatomaceous earth (D.E.) filters are being used to improve sap quality before boiling since they are effective in removing some of the microorganisms.

There is a need to provide a process for the sterilization and/or pasteurization of sap or sap concentrate without denaturing the proteins and other ingredients present therein.

### SUMMARY

According to an embodiment, there is provided a pretreatment apparatus for sterilization and/or pasteurization of sap or sap concentrate with a flow direction which comprises:

a pre-filter of pore size between about 1 μm to about 500 μm; and

a micro-filter of pore size between about 0.1 to about 1 μm;

wherein the micro-filter is connected to and after said pre-filter in the flow direction, the apparatus is for connection before a storage tank, a heating tank or a kettle to filter sap or sap concentrate collected prior to a sterilization and/or a pasteurization treatment.

The pretreatment apparatus may further comprises a secondary treatment apparatus connected after the micro-filter and for connection before a storage tank, a heating tank or a kettle, for further sterilization and/or pasteurization of the sap or sap concentrate.

The pretreatment apparatus of claim 2, wherein said secondary treatment apparatus is chosen from a UV treatment apparatus, a ultrasound apparatus, a CO₂ apparatus, a gamma ray treatment apparatus, a X-ray treatment apparatus, a pulsed light sterilization treatment apparatus, a microwave sterilization treatment apparatus, a pulsed electric field sterilization apparatus, a pulsed magnetic field sterilization apparatus, an ozone sterilization treatment apparatus, or combination thereof.

The pretreatment apparatus may further comprises:

a heating tank connected after the micro-filter and for connection before a kettle or a storage tank in the flow direction.

The pre-filter may be made of nylon, cotton, a polypropylene fiber, polysulfone, steel or any other suitable material, or combinations thereof.

The pre-filter pore size may be 500 μm.

The micro-filter may be made of nylon, cotton, a polypropylene fiber, polysulfone, steel or any other suitable material, or combinations thereof.

The micro-filter pore size may be 1 μm.

The micro-filter pore size may be 0.1 μm.

The pretreatment apparatus may further comprises:

a pump connected to the pre-filter, micro-filter or heating tank.

The pump may have a flow rate between about 50 L/h to about 22 000 L/h.

The pump may have a flow rate between about 7500 L/h to about 22 000 L/h.

According to another embodiment, there is disclosed a method of sterilization and/or pasteurization of sap or sap concentrate; the improvement characterized in the step of:

a) sterilization treatment of the sap or sap concentrate for a time sufficient to eliminate microbial life in the sap or sap concentrate with minimal taste alteration.

The method may be further comprising a step a′) prior to step a):

a′) pre-filtration of collected sap with a pre-filtration treatment.

The pre-filtration treatment may be chosen from a pre-filter of pore size between about 1 μm to about 500 μm, a centrifugation treatment, or combination thereof.

The method may be further comprising a step a″) prior to step a):

a″) micro-filtration of sap or sap concentrate with a micro-filter of pore size between about 0.1 μm to about 1 μm prior to the sterilization treatment of the sap or sap concentrate.

The method may be further comprising the steps a′) and b′) prior to step a)

a′) pre-filtration of collected sap with a pre-filter of pore size between about 1 μm to about 500 μm;

b′) micro-filtration of pre-filtered sap of step a′) with a micro-filter of pore size between about 0.1 μm to about 1 μm prior to the sterilization treatment of said sap or sap concentrate.

The micro-filter may be a micro-filter of pore size between about 0.1 μm to about 0.2 μm.

The micro-filter may be a micro-filter of pore size between about 0.2 μm to about 1 μm.

The micro-filter may be a micro-filter of pore size of about 0.2 μm.

The sterilization treatment is at least one of a heat sterilization treatment, a dry heat sterilization treatment, a tyndallisation treatment, an upperization treatment, a high pressure processing treatment, canning, a UV treatment, a gamma ray treatment, a X-ray treatment, a pulsed light sterilization treatment, a microwave sterilization treatment, a pulsed electric field sterilization, a pulsed magnetic field sterilization, an ozone sterilization treatment, a microfiltration, and combinations thereof.

The microfiltration may be with a micro-filter of pore size between about 0.1 μm to about 0.2 μm, or a micro-filter of pore size between about 0.2 μm to about 1 μm, or a micro-filter of pore size of about 0.2 μm.

The heat sterilization treatment may be from about 100° C. to about 160° C. for about 1 seconds to about 60 seconds, or from about 130° C. to about 150° C. for about 2 seconds to about 8 seconds, or from about 137° C. to about 140° C. for about 2 seconds to about 10 seconds or from about 115° C. to about 137° C. for about 15 to about 130 minutes.

The heat sterilization may be performed by contacting said sap or sap concentrate with a heat exchanger, and the heat exchanger may be at least one of a plate heat exchanger, a shell and tube heat exchanger, a double tube heat exchanger, a triple tube heat exchanger, or combinations thereof.

The sterilization treatment may be a high pressure processing (HPP) treatment. The high pressure processing (HPP) treatment may be from about 145 psi to about 145 000 psi for about 4 minutes to about 30 minutes. The high pressure processing (HPP) treatment may be at about 87 000 psi for about 15 minutes, at about 87 000 psi for about 6 minutes, or at about 87 000 psi for about 4 minutes.

The high pressure processing (HPP) treatment may be performed for a volume of sap or sap concentrate of 1000 L or more.

The pressure processing (HPP) treatment may be performed by direct or indirect compression.

The tyndallisation treatment may be from about 70° C. to about 100° C., for about 30 mins to about 60 mins, for 3 consecutive days.

The upperization treatment may be from about 140° C. to about 150° C., for about 2 secs to about 3 seconds, followed by homogenization of the sap or sap concentrate.

The method UV treatment may be from about 2000 μW s/cm² to about 8500 μW s/cm² of ultraviolet light for a time sufficient to effect sterilization. The UV treatment may be from about 10 kGy to about 50 kGy, or from about 10 kGy or less, or 5 kGy or less.

The gamma ray treatment may be from about 10 kGy to about 50 kGy, or from about 1 kGy to about 15 kGy, or from about 1 kGy to about 10 kGy.

The X-ray treatment may be from about 10 kGy to about 50 kGy, or from about 1 kGy to about 15 kGy or 1 kGy to about 10 kGy.

The pulsed light sterilization treatment may be from about 0.25 J/cm² per pulse, for at least 2 pulses.

The pulsed electric field sterilization may be with an electric field from about 5 kV/cm to about 70 kV/cm, for 5 to 100 pulses of about 2 μsec to about 100 μsec.

The pulsed magnetic field sterilization may be with a pulsed magnetic field from about 5 Tesla to about 50 Tesla, having a pulse frequency of about 5 to about 500 kHz.

The ozone treatment may be from about 10 mg/L or less of ozone.

According to another embodiment, there is provided a method of sterilization and/or pasteurization of sap or sap concentrate; the improvement characterized in the steps of:

a) pre-filtration of collected sap with a pre-filtration treatment;

b) micro-filtration of pre-filtered sap of step a) with a micro-filter of pore size between about 0.1 μm to about 1 μm prior to a pasteurization treatment of the sap or sap concentrate.

The method may further comprise a step c):

c) pasteurization treatment of the micro-filtered sap of step b) by heating from about 50° C. to at about 100° C. for a time sufficient to pasteurize.

The micro-filter may be a micro-filter of pore size between about 0.2 μm to about 1 μm.

According to another embodiment, there is provided a method of pasteurization of sap or sap concentrate; the improvement characterized in the steps of:

pasteurization treatment of the sap or sap concentrate by heating from about 50° C. to at about 100° C. for a time sufficient to pasteurize.

The time sufficient to pasteurize may be from about 10 seconds to about 30 minutes.

The pasteurization treatment may be a High Temperature Short Time (HTST) treatment.

The High Temperature Short Time (HTST) treatment may be from about 71.5° C. to 74° C. for about 15 seconds to about 30 minutes.

The pasteurization treatment may be a thermization treatment.

The thermization treatment may be from about 63° C. to about 65° C., for about 15 to 25 minutes.

The pre-filtration treatment may be chosen from a pre-filter of pore size between about 1 μm to about 500 μm, a centrifugation treatment, or combination thereof.

The sap or sap concentrate may be produced by a plant chosen from an Acer tree, a birch, a pine, a hickory, a poplar, a coconut palm tree (Cocos nucifera), and an agave.

The Acer tree may be chosen from Acer nigrum, Acer lanum, Acer acuminatum, Acer albopurpurascens, Acer argutum, Acer barbinerve, Acer buergerianum, Acer caesium, Acer campbellii, Acer campestre, Acer capillipes, Acer cappadocicum, Acer carpinifolium, Acer caudatifolium, Acer caudatum, Acer cinnamomifolium, Acer circinatum, Acer cissifolium, Acer crassum, Acer crataegifolium, Acer davidii, Acer decandrum, Acer diabolicum, Acer distylum, Acer divergens, Acer erianthum, Acer erythranthum, Acer fabri, Acer garrettii, Acer glabrum, Acer grandidentatum, Acer griseum, Acer heldreichii, Acer henryi, Acer hyrcanum, Acer ibericum, Acer japonicum, Acer kungshanense, Acer kweilinense, Acer laevigatum, Acer laurinum, Acer lobelii, Acer lucidum, Acer macrophyllum, Acer mandshuricum, Acer maximowiczianum, Acer miaoshanicum, Acer micranthum, Acer miyabei, Acer mono, Acer mono×Acer truncatum, Acer monspessulanum, Acer negundo, Acer ningpoense, Acer nipponicum, Acer oblongum, Acer obtusifolium, Acer oliverianum, Acer opalus, Acer palmatum, Acer paxii, Acer pectinatum, Acer pensylvanicum, Acer pentaphyllum, Acer pentapomicum, Acer pictum, Acer pilosum, Acer platanoides, Acer poliophyllum, Acer pseudoplatanus, Acer pseudosieboldianum, Acer pubinerve, Acer pycnanthum, Acer rubrum, Acer rufinerve, Acer saccharinum, Acer saccharum, Acer sempervirens, Acer shirasawanum, Acer sieboldianum, Acer sinopurpurescens, Acer spicatum, Acer stachyophyllum, Acer sterculiaceum, Acer takesimense, Acer tataricum, Acer tegmentosum, Acer tenuifolium, Acer tetramerum, Acer trautvetteri, Acer triflorum, Acer truncatum, Acer tschonoskii, Acer turcomanicum, Acer ukurunduense, Acer velutinum, Acer Acer×peronai, and Acer×pseudoheldreichii.

According to another embodiment, there is provided a pasteurized or sterilized sap or sap concentrate prepared of the method of the present invention.

The pasteurized or sterilized sap or sap concentrate may comprise saccharose, calcium, potassium, magnesium, sodium, vannilic acid, syringic acid, p-Coumaric acid, malic acid, succinic acid, alanine, valine, proline; asparagine, and glutamine.

The pasteurized or sterilized sap or sap concentrate may further comprise at least one of a protein matter, fructose, glucose, an oligosaccharide, a polysaccharide, manganese, phosphorus, aluminum, sulfur, iron, boron, cadmium, molybdenum, selenium, zinc, copper, cis-aconitate, vanillin, hydroxybenzoic acid, syringaldehyde, homovannilic acid, protocatechuic acid, coniferyl aldehyde coniferol, lyoresinol, Isolariciresinol, secoisolariciresinol, dehydroconiferyl alcohol, 5′-methoxy-dehydroconiferyl alcohol, erythro-guaiacylglycerol-b-O-4′-coniferyl alcohol, erythro-guaiacylglycerol-b-O-4′-dihydroconiferyl alcohol, [3-[4-[(6-deoxy-α-L-mannopyranosyl)oxy]-3-methoxyphenyl]methyl]-5-(3,4-dimethoxyphenyl)dihydro-3-hydroxy-4-(hydroxymethyl)-2(3H)-furanone, scopoletin, fraxetin, isofraxidin, gallic acid, ginnalin A (acertannin), ginnalin B, ginnalin C, methyl gallate trimethyl ether, (E)-3,3′-dimethoxy-4,4′-dihydroxy stilbene, ferulic acid, (E)-Coniferyl alcohol, Syringenin, Dihydroconiferyl alcohol, C-veratroylglycol, 2,3-Dihydroxy-1-(4-hydroxy-3,5-dimethoxyphenyl)-1-propanone, 3-Hydroxy-1-(4-hydroxy-3,5-dimethoxyphenyl)propan-1-one, 3′,4′,5′-Trihydroxyacetophenone, 4-Acetylcatechol, 2,4,5-Trihydroxyacetophenone, 1-(2,3,4-trihydroxy-5-methylphenyl)-ethanone, 2-Hydroxy-3′,4′-dihydroxyacetophenone, 4-(dimethoxymethyl)-pyrocatechol, catechaldehyde 3,4-Dihydroxy-2-methylbenzaldehyde, catechol, catechin, epicatechin, fumaric acid, oxalic acid, pyruvic acid, quinic acid, tartaric acid, skimic acid, gluconic acid, lactic acid, acetic acid, sarcosine, glycine, β-amino-isobutyric acid, leucine, allo-isoleucine, isoleucine, arginine, anserine, 3-methyl-histidine, tyrosine, hydroxyl proline, aspartic acid, serine, lysine, threonine, methionine, cysteic acid, Niacin, riboflavin, thiamin, panthothenic acid, choline, vitamin B6, absicissic acid, phaseic acid, auxine, cytokinine, triacontanol, and gibberelline.

The pasteurized or sterilized sap or sap concentrate may comprise:
from about 8.3×10⁻² and up to 1 part saccharose;
from 0.001×10⁻³ and up to 7.8×10⁻³ part calcium;
from 0.001×10⁻³ and up to 7.8×10⁻³ part potassium;
from 0.001×10⁻³ and up to 3.9×10⁻³ part magnesium;
from 0.001×10⁻³ and up to 3.9×10⁻³ part sodium;
from 0.001×10⁻³ and up to 1.6×10⁻³ part vannilic acid;
from 0.001×10⁻³ and up to 1.6×10⁻³ part syringic acid;
from 0.001×10⁻³ and up to 1.6×10⁻³ part p-Coumaric acid;
from 0.001×10⁻¹ and up to 1.0×10⁻¹ of malic acid;
from 0.001×10⁻³ and up to 1.6×10⁻³ part succinic acid;
from 0.001×10⁻³ and up to 7.5×10⁻³ part alanine;
from 0.001×10⁻² and up to 1.6×10⁻² part valine;
from 0.001×10⁻² and up to 1.24×10⁻² part proline;
from 0.001×10⁻² and up to 2.4×10⁻² part asparagine; and
from 0.001×10⁻² and up to 4.7×10⁻² part glutamine.

The pasteurized or sterilized sap or sap concentrate may further comprise:
from 0 and up to 1.6×10⁻³ part of a protein matter;
from 0 and up to 1.5×10⁻¹ part of fructose;
from 0 and up to 1.5×10⁻¹ part of glucose;
from 0 and up to 1.5×10⁻¹ part of an oligosaccharide;
from 0 and up to 1.5×10⁻¹ part of a polysaccharide
from 0 and up to 1.6×10⁻³ part manganese;
from 0 and up to 1.6×10⁻³ part phosphorus;
from 0 and up to 7.8×10⁻⁵ part aluminum;
from 0 and up to 1.6×10⁻³ part sulfur;
from 0 and up to 1.6×10⁻³ part iron;
from 0 and up to 1.6×10⁻³ part boron;
from 0 and up to 1.6×10⁻⁴ part cadmium;
from 0 and up to 1.6×10⁻⁴ part molybdenum;
from 0 and up to 1.6×10⁻⁴ part selenium;
from 0 and up to 1.6×10⁻⁴ part zinc;
from 0 and up to 1.6×10⁻⁴ part copper;
from 0 and up to 1.6×10⁻⁴ part cis-aconitate
from 0 and up to 1.6×10⁻³ part vanillin;
from 0 and up to 1.6×10⁻³ part Hydroxybenzoic acid;
from 0 and up to 1.6×10⁻³ part syringaldehyde;
from 0 and up to 1.6×10⁻³ part homovannilic acid;
from 0 and up to 1.6×10⁻³ part protocatechuic acid;
from 0 and up to 1.6×10⁻³ part coniferyl aldehyde;
from 0 and up to 1.6×10⁻³ part coniferol;
from 0 and up to 1.6×10⁻³ part lyoresinol;
from 0 and up to 1.6×10⁻³ part Isolariciresinol;
from 0 and up to 1.6×10⁻³ part secoisolariciresinol;
from 0 and up to 1.6×10⁻³ part dehydroconiferyl alcohol;
from 0 and up to 1.6×10⁻³ part 5′-methoxy-dehydroconiferyl alcohol;
from 0 and up to 1.6×10⁻³ part erythro-guaiacylglycerol-b-O-4′-coniferyl alcohol;
from 0 and up to 1.6×10⁻³ part erythro-guaiacylglycerol-b-O-4′-dihydroconiferyl alcohol;
from 0 and up to 1.6×10⁻³ part [3-[4-[(6-deoxy-α-L-mannopyranosyl)oxy]-3-methoxyphenyl]methyl]-5-(3,4-dimethoxyphenyl)dihydro-3-hydroxy-4-(hydroxymethyl)-2(3H)-furanone;
from 0 and up to 1.6×10⁻³ part scopoletin;
from 0 and up to 1.6×10⁻³ part fraxetin;
from 0 and up to 1.6×10⁻³ part isofraxidin;
from 0 and up to 1.6×10⁻³ part gallic acid;
from 0 and up to 1.6×10⁻³ part ginnalin A (acertannin);
from 0 and up to 1.6×10⁻³ part ginnalin B;
from 0 and up to 1.6×10⁻³ part ginnalin C;

from 0 and up to 1.6×10⁻³ part methyl gallate trimethyl ether;
from 0 and up to 1.6×10⁻³ part (E)-3,3′-dimethoxy-4,4′-dihydroxy stilbene;
from 0 and up to 1.6×10⁻³ part ferulic acid;
from 0 and up to 1.6×10⁻³ part (E)-Coniferyl alcohol;
from 0 and up to 1.6×10⁻³ part syringenin;
from 0 and up to 1.6×10⁻³ part dihydroconiferyl alcohol;
from 0 and up to 1.6×10⁻³ part C-veratroylglycol;
from 0 and up to 1.6×10⁻³ part 2,3-Dihydroxy-1-(4-hydroxy-3,5-dimethoxyphenyl)-1-propanone;
from 0 and up to 1.6×10⁻³ part 3-Hydroxy-1-(4-hydroxy-3,5-dimethoxyphenyl)propan-1-one;
from 0 and up to 1.6×10⁻³ part 3′,4′,5′-Trihydroxyacetophenone;
from 0 and up to 1.6×10⁻³ part 4-Acetylcatechol;
from 0 and up to 1.6×10⁻³ part 2,4,5-Trihydroxyacetophenone;
from 0 and up to 1.6×10⁻³ part 1-(2,3,4-trihydroxy-5-methylphenyl)-ethanone;
from 0 and up to 1.6×10⁻³ part 2-Hydroxy-3′,4′-dihydroxyacetophenone;
from 0 and up to 1.6×10⁻³ part 4-(dimethoxymethyl)-pyrocatechol;
from 0 and up to 1.6×10⁻³ part Catechaldehyde;
from 0 and up to 1.6×10⁻³ part 3,4-Dihydroxy-2-methylbenzaldehyde;
from 0 and up to 1.6×10⁻³ part catechol;
from 0 and up to 1.6×10⁻³ part catechin;
from 0 and up to 1.6×10⁻³ part epicatechin;
from 0 and up to 1.6×10⁻³ part fumaric acid;
from 0 and up to 1.6×10⁻³ part oxalic acid;
from 0 and up to 1.6×10⁻³ part pyruvic acid;

from 0 and up to 1.6×10⁻³ part quinic acid;
from 0 and up to 1.6×10⁻⁴ part tartaric acid;
from 0 and up to 1.6×10⁻⁴ part skimic acid;
from 0 and up to 1.6×10⁻³ part gluconic acid;
from 0 and up to 1.6×10⁻³ part lactic acid;
from 0 and up to 1.6×10⁻³ part acetic acid;
from 0 and up to 1.6×10⁻³ part sarcosine;
from 0 and up to 7.5×10⁻³ part glycine;
from 0 and up to 1.6×10⁻³ part β-amino-isobutyric acid;
from 0 and up to 1.3×10⁻³ part leucine;
from 0 and up to 4.7×10⁻³ part allo-isoleucine;
from 0 and up to 2.3×10⁻² part isoleucine;
from 0 and up to 4.7×10⁻² part arginine;
from 0 and up to 4.7×10⁻² part anserine;
from 0 and up to 4.7×10⁻² part 3-methyl-histidine;
from 0 and up to 4.7×10⁻² part tyrosine

from 0 and up to 4.7×10⁻² part hydroxyl proline;
from 0 and up to 4.7×10⁻² part aspartic acid;
from 0 and up to 4.7×10⁻² part serine;
from 0 and up to 4.7×10⁻² part lysine;
from 0 and up to 4.7×10⁻² part threonine;
from 0 and up to 4.7×10⁻² part methionine;
from 0 and up to 4.7×10⁻² part cysteic acid

from 0 and up to 1.0×10⁻³ part niacin;
from 0 and up to 5.0×10⁻³ part riboflavin;
from 0 and up to 1.0×10⁻³ part thiamin;
from 0 and up to 1.0×10⁻³ part panthothenic acid;
from 0 and up to 5.0×10⁻³ part choline;

from 0 and up to 1.0×10⁻³ part vitamin B6;

from 0 and up to 3.1×10⁻³ part absicissic acid;
from 0 and up to 6.2×10⁻³ part phaseic acid;
from 0 and up to 3.9×10⁻³ part auxine;
from 0 and up to 1.6×10⁻³ part cytokinine;
from 0 and up to 1.6×10⁻³ part Triacontanol; and
from 0 and up to 1.6×10⁻⁴ part gibberelline.

The pasteurized or sterilized sap or sap concentrate of the present invention may be stored, transported and/or sold in a big container. One may choose to re-pasteurize or re-sterilize the sap or sap concentrate prior to bottling it in smaller container prior to distribution.

The pasteurized or sterilized sap or sap concentrate of the present invention may be further comprising a preservative.

According to another embodiment, there is provided a sap or sap concentrate comprising a preservative.

The preservative may be chosen from propanoic acid, sodium propanoate, calcium propanoate, potassium propanoate, sorbic acid, sodium sorbate, potassium sorbate, and calcium sorbate, benzoic acid, sodium benzoate, potassium benzoate, and calcium benzoate, a paraben, a sulfite, ethylene oxide, propylene oxide, sodium diacetate, dehydroacetic acid, sodium nitrite, caprylic acid, ethyl formate, disodium EDTA, methylchloroisothiazolinone and an antioxidant. The paraben may be chosen from butylparaben, ethylparaben, heptylparaben, methylparaben, propylparaben, or combinations thereof. The sulfite may be chosen from caustic sulphite caramel, sulphite ammonia caramel, Sodium sulphite, Sodium bisulphite, Sodium metabisulphite, potassium metabisulphite, potassium sulphite, calcium sulphite, calcium hydrogen sulphite, potassium hydrogen sulphite, or combinations thereof. The antioxidant may be chosen from ascorbic acid, tocopherol, propyl gallate, tertiary butylhydroquinone, butylated hydroxyanisole, butylated hydroxytoluene, or combinations thereof.

According to another embodiment, there is provided a food or food ingredient comprising the pasteurized or sterilized sap or sap concentrate of the present invention, or the sap or sap concentrate of the present invention.

The food may be a beverage.

According to another embodiment, there is provided a food prepared by sterilizing and/or pasteurizing a pasteurized or sterilized sap or sap concentrate of the present invention, or the sap or sap concentrate of the present invention, combined with at least one food ingredient.

According to another embodiment, there is provided a food prepared by sterilizing and/or pasteurizing a sap or sap concentrate combined with at least one food ingredient.

The sterilizing and/or pasteuring may be at least one of a heat sterilization treatment, a dry heat sterilization treatment, a tyndallisation treatment, an upperization treatment, a high pressure processing treatment, canning, a UV treatment, a gamma ray treatment, a X-ray treatment, a pulsed light sterilization treatment, a microwave sterilization treatment, a pulsed electric field sterilization, a pulsed magnetic field sterilization, an ozone sterilization treatment, a microfiltration, a pasteurization treatment, a High Temperature Short Time (HTST) treatment, a thermization treatment, and combinations thereof.

The at least one food ingredient may be chosen from a fruit, a vegetable, a fruit mixture, a vegetable mixture, a fruit puree, a vegetable puree, a fruit powder, a vegetable powder, a fruit concentrate, a vegetable concentrate, a juice, an alcool, a liquid, a spice, a flavoring agent, a vitamin, an amino acid, an oil, a fat, a vinegar, a dairy ingredient, a bacterial culture, a probiotic culture, a egg derived ingredient, a dietary fiber, and combinations thereof.

According to another embodiment, there is provided a culture medium comprising a pasteurized or sterilized sap or sap concentrate of the present invention.

The culture medium may be a liquid culture medium, or a solid culture medium.

The culture medium may be a microorganism culture medium, a prokaryotic cell culture medium, a eukaryotic cell culture medium, or a plant culture medium.

The following terms are defined below.

The term “sap” is intended to mean a sap produce by a plant chosen from Acer tree, birch, pine, hickory, poplar, palm tree, and agave.

The term “Acer tree” or a “maple tree” is intended to mean a maple tree of a species known to date, such as Acer nigrum, Acer lanum, Acer acuminatum, Acer albopurpurascens, Acer argutum, Acer barbinerve, Acer buergerianum, Acer caesium, Acer campbellii, Acer campestre, Acer capillipes, Acer cappadocicum, Acer carpinifolium, Acer caudatifolium, Acer caudatum, Acer cinnamomifolium, Acer circinatum, Acer cissifolium, Acer crassum, Acer crataegifolium, Acer davidii, Acer decandrum, Acer diabolicum, Acer distylum, Acer divergens, Acer erianthum, Acer erythranthum, Acer fabri, Acer garrettii, Acer glabrum, Acer grandidentatum, Acer griseum, Acer heldreichii, Acer henryi, Acer hyrcanum, Acer ibericum, Acer japonicum, Acer kungshanense, Acer kweilinense, Acer laevigatum, Acer laurinum, Acer lobelii, Acer lucidum, Acer macrophyllum, Acer mandshuricum, Acer maximowiczianum, Acer miaoshanicum, Acer micranthum, Acer miyabei, Acer mono, Acer mono×Acer truncatum, Acer monspessulanum, Acer negundo, Acer ningpoense, Acer nipponicum, Acer oblongum, Acer obtusifolium, Acer oliverianum, Acer opalus, Acer palmatum, Acer paxii, Acer pectinatum, Acer pensylvanicum, Acer pentaphyllum, Acer pentapomicum, Acer pictum, Acer pilosum, Acer platanoides, Acer poliophyllum, Acer pseudoplatanus, Acer pseudosieboldianum, Acer pubinerve, Acer pycnanthum, Acer rubrum, Acer rufinerve, Acer saccharinum, Acer saccharum, Acer sempervirens, Acer shirasawanum, Acer sieboldianum, Acer sinopurpurescens, Acer spicatum, Acer stachyophyllum, Acer sterculiaceum, Acer takesimense, Acer tataricum, Acer tegmentosum, Acer tenuifolium, Acer tetramerum, Acer trautvetteri, Acer triflorum, Acer truncatum, Acer tschonoskii, Acer turcomanicum, Acer ukurunduense, Acer velutinum, Acer Acer×peronai, Acer×pseudoheldreichii or any new species not yet known.

The term “palm tree” is intended to mean a coconut palm tree (Cocos nucifera) from which coco water may be obtained from the coconuts.

The term “pasteurization” is intended to mean the reduction of the number of viable pathogens in a product so they are unlikely to cause disease (assuming the pasteurized product is stored as indicated and consumed before its expiration date). Commercial-scale sterilization of food is not common because it adversely affects the taste and quality of the product. Preferably the pasteurization does not affect the taste or texture of the product.

The term “sterilization” is intended to mean a procedure that kills all spore, microorganisms, yeasts, molds. In the context of food, the procedure is functional irrespective of the pH of the medium. It allows the preservation of the product for a long time (months).

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 illustrates the apparatus diagram in accordance with one embodiment of the present invention.

FIG. 2 illustrates the pasteurization process diagram in accordance with one embodiment of the present invention.

FIG. 3 illustrates the microbial counts before and after pasteurization of maple sap at different temperatures.

FIG. 4 illustrates the combined effect of microfiltration or UV treatment prior to pasteurization.

It will be noted that throughout the appended drawings, like features are identified by like reference numerals.

### DETAILED DESCRIPTION OF THE PREFERRED EMBODIMENTS

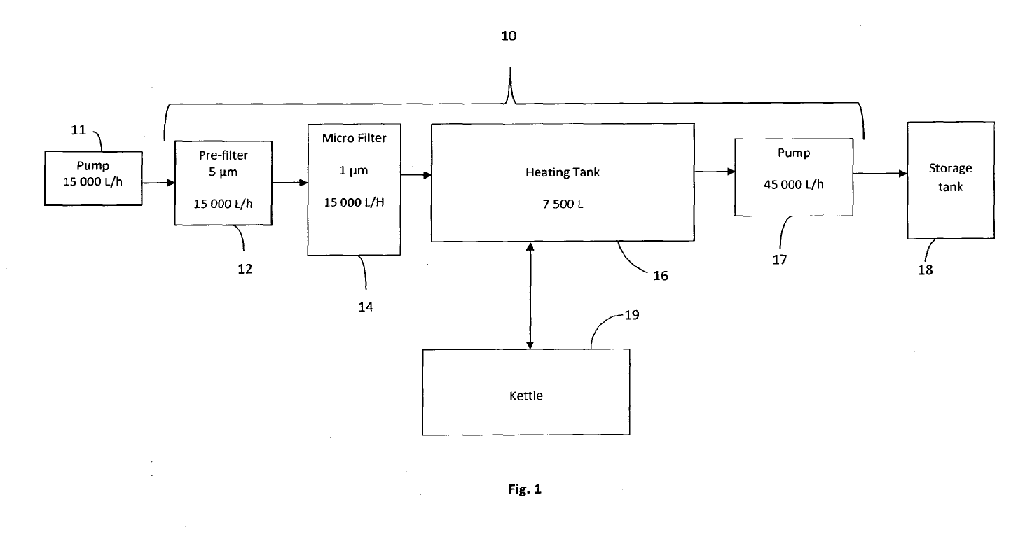

Referring now to the drawings, and more particularly to FIG. 1, a block diagram illustrates one embodiment of the apparatus 10, which consists essentially of a pre-filter 12 (for example, any gauze like material such as cotton cheese, or any suitable nylon membranes) having pores sizes of between about 1 μm to about 500 μm), followed by a micro-filter 14 (between 0.1 to about 1 μm) and a heating tank 16, or a storage tank or other means of storage. For example, the apparatus 10 may be installed in a plant where sap is treated to be reduced to a more concentrated form, syrup or other products, such as a sugarbush or sugarshack. According to some embodiments, the apparatus 10 may be for connection before a storage tank, a heating tank 16, and/or a kettle to filter sap or sap concentrate collected prior to a sterilization and/or pasteurization treatment of the sap or sap concentrate. According to an embodiment, the apparatus may comprise a micro-filter of pore size of 0.2 μm, for use in plants where sap is treated to be reduced to a more concentrated form, such as syrup or other products, or for the sale of sap on site. According to another embodiment, the apparatus may comprise a micro-filter of pore size of larger than 0.2 μm (e.g. 0.45 μm to 0.8 μm), for use in plants where sap is treated and then transported to a sterilization or pasteurization plant for subsequent treatment.

According to one embodiment, the apparatus 10 may further comprise a secondary treatment apparatus that may be connected after said micro-filter and for connection before a storage tank, a heating tank or a kettle, for further sterilization and/or pasteurization of said sap or sap concentrate. The secondary treatment apparatus may be chosen from a UV treatment apparatus, a gamma ray treatment apparatus, a X-ray treatment apparatus, a pulsed light sterilization treatment apparatus, a microwave sterilization treatment apparatus, a pulsed electric field sterilization apparatus, a pulsed magnetic field sterilization apparatus, an ozone sterilization treatment apparatus, or combination thereof. The secondary treatment apparatus 10 may be for connection before the storage tank, heating tank 16 or kettle, or storage tank or other means of storage. If the apparatus 10 is installed in a plant it may use any of the existing pumps, kettle and storage tanks available in the facility. According to another embodiment, the apparatus 10 may further include a heating tank 16 connected to the micro-filter and for connection before a kettle or a storage tank in the flow direction. According to another embodiment of the apparatus 10, it includes a pump 11 which can 1) collect sap from trees, 2) bring it to pass firstly through a pre-filter 12 to remove debris and other particles, 3) secondly a micro-filter 14 to remove microorganisms such as bacteria, yeast, mold and fungi, among others and 4) to the sap collected in a heating tank 16, or a storage tank or other means of storage, for subsequent sterilization and/or pasteurization.

According to another embodiment, the pump 11 may have a flow of from about 50 L/h to about 22 000 L/h, or from about 200 L/h to about 15 000 L/h for collection of sap and for going through the filter 12 and micro-filter 14. According to another embodiment, the pump 11 may have a flow of from about 50 L/h to about 7 500 L/h, or from about 200 L/h to about 7500 L/h for bringing the filtered sap into the heating tank 16.

According to an embodiment, the sterilization and/or pasteurization of the filtered sap may take place in the heating tank 16.

According to another embodiment, a pump 17 may draw the pasteurized sap to a storage tank 18 or to a kettle 19. According to another embodiment, the sap is moved from the heating tank 16 (or a storage tank or other means of storage) to the kettle by a different pump (not shown in FIG. 1). According to another embodiment, the pump 17 may have a flow of from about 15 000 L/h to about 45 000 L/h for bringing the sterilized and/or pasteurized sap into the storage tank 18.

According to one embodiment, the kettle 19 may be a regular kettle used for concentrating the sterilized and/or pasteurized sap.

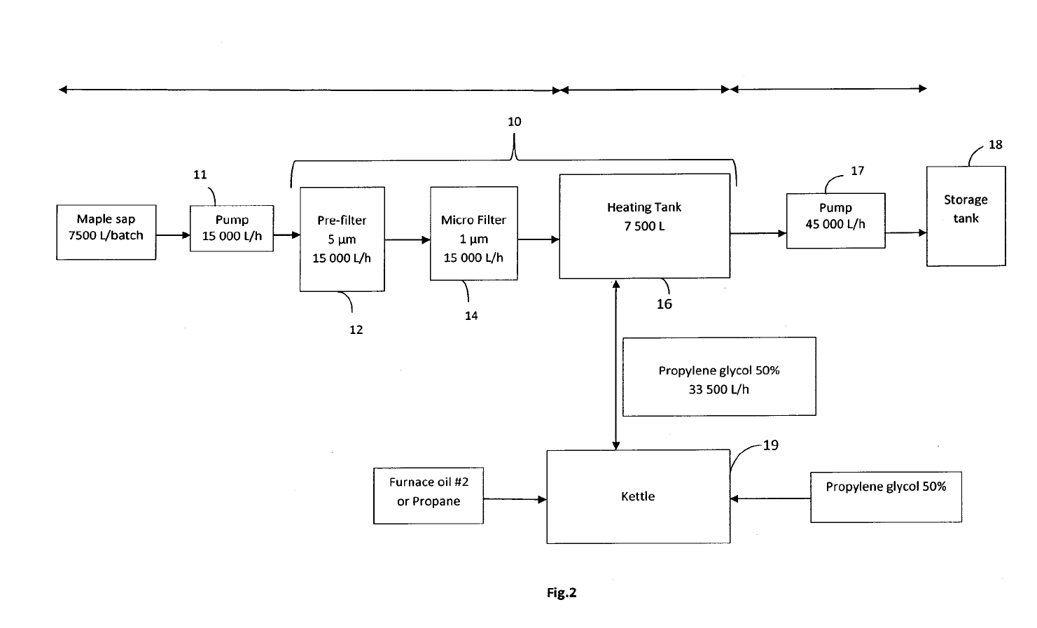

Now referring to FIG. 2, which illustrates a sterilization and/or pasteurization process diagram according to one embodiment of the present invention where the sap is obtained from a maple tree. The sterilization and/or pasteurization process may include three steps, namely 1) a pre-filtration step, 2) a micro-filtration step and 3) a sterilization and/or pasteurization treatment step. Basically, the pre-filtering may be effected as specified and with the pre-filter 12, the micro-filtering is effected as specified and with the micro-filter 14. Pasteurization takes place as follows and in the heating tank 16.

It is essential to inactivate endogenous flora (microorganisms present in the sap collected) by a pasteurization or sterilization treatment that does not alter the endogeous nutraceutical compounds or the intrinsic qualities of the sap. Pasteurization relies on the principle that most harmful microorganisms can be killed by heat. The most effective way to kill most microorganisms is by boiling, but this compromises the flavor of the liquid. Pasteurization strikes a median happy balance between boiling and not boiling the sap, keeping the flavor delicious while making the food safer. In addition to minimizing the risk of sickness and intoxication, pasteurization also makes foods more shelf stable.

According to another embodiment of the present invention, the liquid may be sterilized using any suitable sterilization method know in the art, while having minimal taste alteration, for preserving the organoleptic qualities of the liquids. According to an embodiment, the sterilization of the sap or sap concentrate may be performed for a time sufficient to eliminate microbial life in the sap or sap concentrate with minimal taste alteration, for preserving the organoleptic qualities of the liquids. As used herein, time sufficient is intended to mean the time necessary to greatly reduce and preferably eliminate the microbial life in the sap or sap concentrate with minimal taste alteration.

According to another embodiment, the sap or sap concentrate may be subjected to a pre-filtration treatment with a pre-filter of pore size between about 500 μm to about 1 μm, prior to sterilization. A pre-filtration step (on which may be a coarse filtration medium such as cheesecloth or even fine filtrations medium such as a nylon membrane. The pre-filtration medium (or filter) may have pores of about 1 μm to about 10 μm, or from about 1 μm to about 20 μm, or from about 1 μm to about 30 μm, or from about 1 μm to about 40 μm, or from about 1 μm to about 50 μm, or from about 1 μm to about 60 μm, or from about 1 μm to about 70 μm, or from about 1 μm to about 80 μm, or from about 1 μm to about 90 μm, or about 1 μm to about 500 μm, or about 5 μm to about 10 μm, or from about 5 μm to about 20 μm, or from about 5 μm to about 30 μm, or from about 5 μm to about 40 μm, or from about 5 μm to about 50 μm, or from about 5 μm to about 60 μm, or from about 5 μm to about 70 μm, or from about 5 μm to about 80 μm, or from about 5 μm to about 90 μm, or about 5 μm to about 500 μm, and preferably of about 5 μm. The filter material should be suitable for food quality product preparation, and is performed to remove large particulate matter which may be found in the sap or sap concentrate.

According to another embodiment, the pre-filtration treatment may also be a process to remove particules or a centrifugation treatment, which may be performed with any suitable centrifugation equipment, in batch mode or continuous mode, in order to remove large particulate matter which may be found in the sap or sap Concentrate.

According to an embodiment, the sap or sap concentrate may be subjected to a micro-filtration step (for example on a nylon membrane of about 0.1 μm to about 1 μm, and preferably of about 0.1 μm). According to another embodiment, the pre-filtration step may be followed by a micro-filtration step (for example on a nylon membrane of about 0.1 μm to about 1 μm, and preferably of about 0.1 μm). The membrane may be made of nylon, cotton, a polypropylene fiber, polysulfone, steel or any other suitable material, or combinations thereof.

The pore sizes of the micro-filter may be from about 0.1 μm to about 1 μm, or from about 0.1 μm to about 0.9 μm, or from about 0.1 μm to about 0.8 μm, or from about 0.1 μm to about 0.7 μm, or from about 0.1 μm to about 0.6 μm, or from about 0.1 μm to about 0.5 μm, or from about 0.1 μm to about 0.4 μm, or from about 0.1 μm to about 0.3 μm, or from about 0.1 μm to about 0.2 μm, or from about 0.2 μm to about 1 μm, or from about 0.2 μm to about 0.9 μm, or from about 0.2 μm to about 0.8 μm, or from about 0.2 μm to about 0.7 μm, or from about 0.2 μm to about 0.6 μm, or from about 0.2 μm to about 0.5 μm, or from about 0.2 μm to about 0.4 μm, or from about 0.2 μm to about 0.3 μm, or from about 0.3 μm to about 1 μm, or from about 0.3 μm to about 0.9 μm, or from about 0.3 μm to about 0.8 μm, or from about 0.3 μm to about 0.7 μm, or from about 0.3 μm to about 0.6 μm, or from about 0.3 μm to about 0.5 μm, or from about 0.3 μm to about 0.4 μm, or from about 0.4 μm to about 1 μm, or from about 0.4 μm to about 0.9 μm, or from about 0.4 μm to about 0.8 μm, or from about 0.4 μm to about 0.7 μm, or from about 0.4 μm to about 0.6 μm, or from about 0.4 μm to about 0.5 μm, or from about 0.5 μm to about 1 μm, or from about 0.5 μm to about 0.9 μm, or from about 0.5 μm to about 0.8 μm, or from about 0.5 μm to about 0.7 μm, or from about 0.5 μm to about 0.6 μm, or from about 0.6 μm to about 1 μm, or from about 0.6 μm to about 0.9 μm, or from about 0.6 μm to about 0.8 μm, or from about 0.6 μm to about 0.7 μm, or from about 0.7 μm to about 1 μm, or from about 0.7 μm to about 0.9 μm, or from about 0.7 μm to about 0.8 μm, or from about 0.8 μm to about 1 μm, or from about 0.8 μm to about 0.9 μm. According to a preferred embodiment, the filter sizes for microfiltration are between about 0.2 μm to about 1 μm, or from about 0.1 μm to about 0.2 μm, or from about 0.25 μm to about 0.8 μm. The filter material should be suitable for food quality product preparation. According to an embodiment, microfiltration with a microfilter of pore size 0.2 μm or smaller provides a sap or sap concentrate that is sterilized. Further sterilization with other processes such as heat sterilization is therefore unnecessary.

According to an embodiment, the sterilization treatment may be at least one of a heat sterilization treatment (also known as UHT treatment), a dry heat sterilization treatment, a tyndallisation treatment, an upperization treatment, a high pressure processing treatment, canning, a UV treatment, a gamma ray treatment, a X-ray treatment, a pulsed light sterilization treatment, a microwave sterilization treatment, a pulsed electric field sterilization, a pulsed magnetic field sterilization, an ozone sterilization treatment, a microfiltration, and combinations thereof.

The heat sterilization treatment may be performed from about 100° C. to about 160° C. for about 1 seconds to about 60 seconds, or from about 130° C. to about 150° C. for about 2 seconds to about 8 seconds or from about 137° C. to about 140° C. for about 2 seconds to about 10 seconds, or for at least one of 131° C. for 14 seconds, 138° C. for 4 seconds, and 145° C. for 2 seconds, or from about 115° C. to about 137° C. for about 15 to about 130 minutes.

According to another embodiment, the sterilization treatment may be performed by a tyndallisation treatment. Tyndallization essentially consists of heating the sap or sap concentrate for 30 to 60 minutes for three days in a row (usually by boiling it). On the second day most of the spores that survived the first day will have germinated into bacterial cells. These cells will be killed by the second day's heating. The third day kills bacterial cells from late-germinating spores. During the waiting periods over the three days, the substance being sterilized is kept at a warm room temperature; i.e., a temperature that is conducive to germination of the spores. Germination also requires a moist environment. When the environment is conducive to the formation of cells from spores, the formation of spores from cells does not occur. The Tyndallization process is generally effective, but its reliability is not considered 100% certified. Thus, tyndallization is performed from about 70° C. to about 100° C., for about 30 minutes to about 60 minutes, for 3 consecutive days.

According to another embodiment, the sterilization treatment may also be performed by an upperization treatment. This technique uses intense heat (water vapor stream at 140° C. to 150° C.) for a few seconds (2-3 seconds), and is followed by homogenization. It allows a liquid to be preserved for about 5 to about 6 months, without the affecting the flavor, and lessen the loss of vitamins. It has the disadvantages of requiring a lot of energy. The liquid is sprayed in the form of small droplets, for a very short time at very high temperatures, (eg, 2 seconds at 150° C.), with a stream of saturated water vapor. Contact with the heat is uniform over the droplet propelled into heat and microbial loads can be destroyed more easily than for the bulk pasteurization process. Thus, the upperization treatment is from about 140° C. to about 150° C., for about 2 seconds to about 3 seconds, followed by homogenization of said sap or sap concentrate.

The heat sterilization treatment, or any of the treatment types requiring heating of the sap or sap concentrate may be performed by contacting the sap or sap concentrate with heating means which bring the liquid to the desired temperature very rapidly. The period of time necessary for sterilization may vary greatly depending on the technology employed for the sterilization by heat treatment. The time may range from a few seconds or minutes of exposure to a specified temperature. For example, a fluid may be exposed to the sterilization temperature in an apparatus having a large surface of area of exposure allowing to bring the whole volume of liquid rapidly to the desired temperature and achieve the sterilization. Examples include heat exchangers through which the liquid flows and is brought to the desired temperature almost instantaneously, as the volume of contact of the fluid and the heat exchanger apparatus is very small during the flow of the liquid through the apparatus. Examples of heat exchanger include heat exchanger suitable for the processing of food, such as plate heat exchangers, shell and tube heat exchangers, double tube heat exchangers, triple tube heat exchangers, or combinations thereof. The sap or sap concentrate may be boiled for a period of time.

According to another embodiment, the sterilization treatment may also be a high pressure processing (HPP) treatment (also known as pascalization). HPP treatment stops chemical activity caused by microorganisms that play a role in the deterioration of foods. The treatment occurs at low temperatures and does not include the use of food additives. The treatment may be conveniently used in the treatment of food, including sap and sap concentrate, as it does not alter the taste, texture, or color of the products, but the shelf life of the product is increased. However, some treated foods still require cold storage because pascalization does not stop all enzyme activity caused by proteins, and may also not kill all microorganisms.

Therefore, according to another embodiment, when said sterilization treatment is a HPP treatment, a micro-filtration is preferably included with filter sizes between about 0.2 μm to about 2 μm. Microfiltration and HPP may or may not be preceded by a pre-filtration treatment in order to yield sterile sap or sterile concentrated sap. According to another embodiment, prefiltration may be combined with a HPP treatment in order to obtain pasteurized sap or pasteurized concentrated sap.

According to an embodiment, HPP is performed from about 145 psi to about 145 000 psi for about 4 minutes to about 30 minutes, or from about 50 000 psi to about 87 000 psi for about 4 minutes to about 30 minutes. According to another embodiment, HPP is performed 87 000 psi for about 15 minutes, or at about 87 000 psi for about 6 minutes, and according to another embodiment it is performed at about 87 000 psi for about 4 minutes. According to another embodiment, HPP may be performed for volumes of sap or sap concentrate up to 1000 L.

The HPP treatment can also be combined with another sterilization and/or pasteurization treatment. For example, HPP may be used conventionally to sterilize the sap or sap concentrate, while an optional second treatment could be pre-heat treating of the sap or sap concentrate, freezing, or it may be subjected twice to different pressures. According to another embodiment, the sterilization and/or pasteurization treatment may be done at different time in the self-life of the sap or sap concentrate. For example, the sap or sap concentrate could be pasteurized, and after few days it could be subjected to HPP.

Ultraviolet light treatment, as well as other mode of sterilization involving radiation, such as gamma ray sterilization treatment and X-ray sterilization treatment, as other methods of sterilization that may be used in the method of the present invention. Suitable UV treatment may be achieved by subjecting the sap or sap concentrate to about 2000 μW s/cm² to about 8000 μW s/cm² of ultraviolet light as a microbicide treatment. Suitable UV treatment may also be achieved by subjecting the sap or sap concentrate to a UV treatment of about more than 10 kGy to 50 kGy to destroy all microorganisms, to a UV treatment about 10 kGy or less, which is suitable to kill all pathogens that did not sporulate; it may also be achieved by subjecting the sap or sap concentrate to a UV treatments about 5 kGy or less without altering the product. Preferably, the dose of UV irradiation is limited to 17.5 kGy for organoleptic reasons.

Suitable gamma ray treatment may be achieved by subjecting the sap or sap concentrate to a gamma ray treatment from about 1 kGy to about 50 kGy, or from about 1 kGy to about 15 kGy, or from about 1 kGy to about 10 kGy. Preferably, the dose of the gamma ray treatment is limited to 17.5 kGy for organoleptic reasons.

Suitable X-ray treatment may be achieved by subjecting the sap or sap concentrate to an X-ray treatment from about 1 kGy to about 50 kGy, or from about 1 kGy to about 15 kGy, or from about 1 kGy to about 10 kGy. Preferably, the dose of the gamma ray treatment is limited to 17.5 kGy for organoleptic reasons.

According to another embodiment, the sterilization may also be achieved with a pulsed light sterilization treatment. This method is based on a number of very intense flashes of light emitted for example by a quartz lamp containing xenon. The intense flash of light emitted by the lamp is focused on the surface to be treated by a reflector. This emits a light of wavelengths between 200 nm in the ultraviolet and 1 mm in the near infrared. This feature of the spectrum, the extremely short pulses (10⁻⁶ to 0.1 seconds) and intensity of the energy released, provide the pulsed light sterilization treatment with its sterilizing properties. This intensity represents more than 20,000 times sunlight on the surface of the earth. According to an embodiment, the pulsed light sterilization treatment may be from about 0.25 J/cm² per pulse, for at least 2 pulses.

According to another embodiment, the sterilization may also be achieved with a pulsed electric field sterilization. The process of pulsed electric fields applied to the food industry, is to subject the food to electric fields of very high intensity (5 to 70 kV/cm), repeatedly (pulsed), for very short times (of order of a microsecond), in order to destroy the microorganisms contained therein.

Exposure of a microorganism to a pulsed electric field high enough, leads to a phenomenon of membrane permeabilization. This break known as electroporation, may be reversible if the field strength and exposure time are moderate, but if these values increase sharply, membrane rupture is irreversible and it is the death of the microorganism. According to an embodiment, pulsed electric field sterilization may be performed with an electric field from about 5 kV/cm to about 70 kV/cm, for 5 to 100 pulses of about 2 μsec to about 100 μsec.

According to another embodiment, the sterilization may also be achieved with a pulsed magnetic field sterilization. The effects of magnetic fields on microorganisms are still unknown and several theories have been proposed, but to date the mode of action of pulsed magnetic fields on microorganisms is not well understood. One hypothesis is that the magnetic field created in the travel position of the ions within the membrane, and can open or close membrane channels, and/or impart a torsional force on the dipoles membrane, resulting in localized fractures. A pulsed field from 5 to 50 T, at a pulse frequency of between 5 and 500 kHz, allows to get reductions of at least two order of magnitude of the populations of pathogens in different foods.

Therefore, according to an embodiment, the pulsed magnetic field sterilization may be performed with a pulsed magnetic field from about 5 Tesla to about 50 Tesla, having a pulse frequency of about 5 to about 500 kHz.

According to yet another embodiment, the sterilization may also be achieved with an ozone treatment. The typical concentrations of ozone used for the treatment of food by the ambient air, such as in cold rooms, are of the order of 2 to 7 ppm. For the treatment of water, a concentration of 10 mg/L or less of ozone is as effective as a chlorine dose of 200 mg/L in destroying a wide range of pathogens. According to an embodiment, the ozone treatment may be performed with about 10 mg/L or less of ozone.

According to an embodiment of the present invention, the liquid may be pasteurized using any suitable pasteurization method known in the art. Preferably, the pasteurization method will be one that minimizes or does not alter the organoleptic qualities of the liquid being treated, such as the taste, texture, etc. The liquid may be pasteurized at several temperatures, for example at about 121° C. for at least about 10 minutes. According to some embodiment, the pasteurization temperature may be a temperature may be from about 50° C. to about 121° C. or from about 55° C. to about 121° C. Preferably, the pasteurization temperature may be from about 50° C. to about 100° C., and most preferably from about 50° C. to about 100° C. for preserving the organoleptic qualities of the liquid. The pasteurization step may be performed for a time sufficient to achieve the pasteurization effect (i.e. a reduction of the microbial load of the liquid). The period of time necessary for pasteurization may vary greatly depending on the technology employed for the pasteurization, for example flash pasteurization, cold pasteurization, or other such techniques. The time may range from a few seconds or minutes of exposure to a specified temperature. For example, a fluid may be exposed to the pasteurization temperature in an apparatus having a large surface of area of exposure allowing to bring the whole volume of liquid rapidly to the desired temperature and achieve the pasteurization. Alternatively, the volume of liquid being pasteurized may be heated in a tank and require longer period of time for achieving pasteurization. According to some embodiment of the present invention, the pasteurization methods are two primary methods of pasteurization: the liquid can be heated to about 55° C. and held there for at least about 20 minutes, or the liquid can be pasteurized at about 80° C. for a minimum of about 10 minutes. According to yet another embodiment, the pasteurization may also be accomplished by heating the liquid at about 50° C. to about 100° C., for about 10 seconds to about 30 minutes. According to another embodiment, the pasteurization treatment may be a High Temperature Short Time (HTST) treatment, where the liquid can be in a continuous flow while subjected to temperatures of about 71.5° C. to 74° C. for about 15 to 30 seconds. According to another embodiment, the pasteurization treatment may be a thermization treatment, where the liquid can be subjected to temperatures of about 63° C. to about 65° C., for about 15 to 25 seconds.

However, the pasteurization may be performed over a preferred range of temperature and time that range from about 50° C. for at least about 30 minutes, or from about 55° C. for at least about 20 minutes, to about 80° C. for at least about 10 minutes. For example, the temperature and time may be from about 50° C. for at least about 30 minutes, or from about 51° C. for about at least about 30 minutes, or from about 52° C. for about at least about 28 minutes, or from about 53° C. for about at least about 26 minutes, or from about 54° C. for about at least about 24 minutes, about 55° C. for at least about 20 minutes, or about 56° C. for at least about 20 minutes, or about 57° C. for at least about 20 minutes, or about 58° C. for at least about 20 minutes, or about 59° C. for at least about 20 minutes, or about 60° C. for at least about 20 minutes, or about 61° C. for at least about 20 minutes, or about 62° C. for at least about 20 minutes, or about 63° C. for at least about 20 minutes, or about 64° C. for at least about 20 minutes, or from about 64° C. for at least about 19 minutes, or from about 65° C. for at least about 19 minutes, or from about 66° C. for at least about 19 minutes, or from about 66° C. for at least about 18 minutes, or from about 67° C. for at least about 18 minutes, or from about 68° C. for at least about 17 minutes, or from about 69° C. for at least about 17 minutes, or from about 69° C. for at least about 16 minutes, or from about 70° C. for at least about 16 minutes, or from about 71° C. for at least about 16 minutes, or from about 69° C. for at least about 15 minutes, or from about 72° C. for at least about 15 minutes, or from about 73° C. for at least about 14 minutes, or from about 69° C. for at least about 16 minutes, or from about 74° C. for at least about 14 minutes, or from about 74° C. for at least about 13 minutes, or from about 75° C. for at least about 13 minutes, or from about 76° C. for at least about 13 minutes, or from about 76° C. for at least about 12 minutes, or from about 77° C. for at least about 12 minutes, or from about 78° C. for at least about 11 minutes, or from about 79° C. for at least about 11 minutes, or from about 79° C. for at least about 10 minutes, or from about 80° C. for at least about 10 minutes. The temperature and length of the pasteurization treatment may be chosen depending on several factors. For example, in industrial scale setting, the systems in place may employ a system where the pasteurization is performed at about 80° C. for at least about 10 minutes. In sugar house setting, the pasteurization is performed at about 63° C. for at least about 20 minutes, which are conditions less demanding energetically for small scale operations. For sugar house systems, a 0.5° C. increase in temperature may be suggested to enable lower energy cost treatments, at a lower temperature for a longer time (e.g. 63° C. for about 20 minutes). Pasteurization reactions performed at temperatures above 80° C. for at least about 10 minutes cause Maillard reaction in the liquid, that bring about chemical changes in the liquid and change the taste of the final product. These may affect the organoleptic qualities of the sap or sap concentrate and are usually undesirable, depending on the final commercial use of the sap or sap concentrate. Pasteurization can be done using a continuous method, where the liquid flows through a pasteurization system, or by using a batch method, where one batch of the liquid is pasteurized at a time. Continuous pasteurization is popular for large producers, because it does not slow the supply line as much as batch pasteurization does.

In one aspect of the present invention, the pasteurization process which reduces the endogenous flora and maintains the intrinsic qualities of the product (sap, concentrated sap of maple, maple syrup or diluted maple syrup) is a pasteurization process combining a pre-filtration treatment step. According to an embodiment, the pre-filtration treatment may be a coarse filtration medium such as cheesecloth or even fine filtrations medium such as a nylon membrane. The pre-filtration medium (or filter) may have pores of about 5 μm to about 10 μm, or from about 5 μm to about 20 μm, or from about 5 μm to about 30 μm, or from about 5 μm to about 40 μm, or from about 5 μm to about 50 μm, or from about 5 μm to about 60 μm, or from about 5 μm to about 70 μm, or from about 5 μm to about 80 μm, or from about 5 μm to about 90 μm, 5 μm to about 100 μm, and preferably of about 5 μm. The filter material should be suitable for food quality product preparation. According to another embodiment, the pre-filtration treatment may also be a centrifugation treatment, which may be performed with any suitable centrifugation equipment, in batch mode or continuous mode, in order to remove large particulate matter which may be found in the sap or sap concentrate.

The pre-filtration is followed by a micro-filtration step (for example on a nylon membrane of about 0.1 μm to about 1 μm, and preferably of about 0.1 μm). The pore sizes may be from about 0.1 μm to about 1 μm, or from about 0.1 μm to about 0.9 μm, or from about 0.1 μm to about 0.8 μm, or from about 0.1 μm to about 0.7 μm, or from about 0.1 μm to about 0.6 μm, or from about 0.1 μm to about 0.5 μm, or from about 0.1 μm to about 0.4 μm, or from about 0.1 μm to about 0.3 μm, or from about 0.1 μm to about 0.2 μm, or from about 0.2 μm to about 1 μm, or from about 0.2 μm to about 0.9 μm, or from about 0.2 μm to about 0.8 μm, or from about 0.2 μm to about 0.7 μm, or from about 0.2 μm to about 0.6 μm, or from about 0.2 μm to about 0.5 μm, or from about 0.2 μm to about 0.4 μm, or from about 0.2 μm to about 0.3 μm, or from about 0.3 μm to about 1 μm, or from about 0.3 μm to about 0.9 μm, or from about 0.3 μm to about 0.8 μm, or from about 0.3 μm to about 0.7 μm, or from about 0.3 μm to about 0.6 μm, or from about 0.3 μm to about 0.5 μm, or from about 0.3 μm to about 0.4 μm, or from about 0.4 μm to about 1 μm, or from about 0.4 μm to about 0.9 μm, or from about 0.4 μm to about 0.8 μm, or from about 0.4 μm to about 0.7 μm, or from about 0.4 μm to about 0.6 μm, or from about 0.4 μm to about 0.5 μm, or from about 0.5 μm to about 1 μm, or from about 0.5 μm to about 0.9 μm, or from about 0.5 μm to about 0.8 μm, or from about 0.5 μm to about 0.7 μm, or from about 0.5 μm to about 0.6 μm, or from about 0.6 μm to about 1 μm, or from about 0.6 μm to about 0.9 μm, or from about 0.6 μm to about 0.8 μm, or from about 0.6 μm to about 0.7 μm, or from about 0.7 μm to about 1 μm, or from about 0.7 μm to about 0.9 μm, or from about 0.7 μm to about 0.8 μm, or from about 0.8 μm to about 1 μm, or from about 0.8 μm to about 0.9 μm. According to a preferred embodiment, the filter sizes for microfiltration are between about 0.2 μm to about 1 μm, or from about 0.1 μm to about 0.2 μm, or from about 0.25 μm to about 0.8 μm. The filter material should be suitable for food quality product preparation.

The micro-filtration step may further be followed by a continuously mild heat pasteurization treatment step (about 63° C. for about 20 minutes or about 80° C. for about 10 minutes, or any suitable intermediate temperature and time combination, for example as listed above). The present pasteurization process can eliminate the microbial load of treated products including psychotropic, yeasts and molds. On average, endogenous flora reduction of approximately 7 log was obtained and no microorganism was detected after four months storage at about 4° C. The physico-chemical analysis showed that the new pasteurization process resulted in only minor changes in terms of product features including a slight decline in total solids and an increase in invert sugar. No changes were observed at the level of pH, which remained stable between 6 and 7 during storage. These minor changes do not affect the integrity of the product and its taste.

In a particular aspect of the invention, the sterilization and/or pasteurization step involves processing the filtered sap at a temperature of less than about 121° C. It should be noted that the present invention contemplates the use of the various other sterilization and/or pasteurization methods used in the food industry. The sterilization and/or pasteurization step may be performed with any suitable heating/pasteurization system that may be adapted for the heating of the filtered sap. According to some embodiment, non limiting examples of heating systems that may be suitably adapted to the sterilization and/or pasteurization process of the present invention include electric heating systems, combustion heating system (e.g. through combustion of oil, light oil, natural gas, gasoline, kerosene, wood, or any other suitable fuels), radiation heating systems (e.g. infrared, solar), dielectric heating (microwave heating), The specific temperature and time based food treatment methods described herein are not meant to be exhaustive, but rather indicative that maple based products may be made based on conventional food treatment methods.

According to another embodiment of the present invention, there is disclosed a pasteurized sap or sap concentrate prepared according to the method described above. According to one embodiment, the pasteurized sap or sap concentrate may comprise, saccharose, calcium, potassium, magnesium, sodium, vannilic acid, syringic acid, p-Coumaric acid; malic acid; succinic acid; alanine; valine, proline; asparagine; and glutamine. Also, according to another embodiment, the pasteurized sap or sap concentrate according to the present invention may also further comprise at least one of a protein matter, fructose, glucose, an oligosaccharide, a polysaccharide, manganese, phosphorus, aluminum, sulfur, iron, boron, cadmium, molybdenum, selenium, zinc, copper, cis-aconitate, vanillin, hydroxybenzoic acid, syringaldehyde, homovannilic acid, protocatechuic acid, coniferyl aldehyde coniferol, lyoresinol, Isolariciresinol, secoisolariciresinol, Dehydroconiferyl alcohol, 5′-methoxy-dehydroconiferyl alcohol, erythro-guaiacylglycerol-b-O-4′-coniferyl alcohol, erythro-guaiacylglycerol-b-O-4′-dihydroconiferyl alcohol, [3-[4-[(6-deoxy-α-L-mannopyranosyl)oxy]-3-methoxyphenyl]methyl]-5-(3,4-dimethoxyphenyl)dihydro-3-hydroxy-4-(hydroxymethyl)-2(3H)-furanone, scopoletin, fraxetin, isofraxidin, gallic acid, ginnalin A (acertannin), ginnalin B, ginnalin C, methyl gallate trimethyl ether, (E)-3,3′-dimethoxy-4,4′-dihydroxy stilbene, ferulic acid, (E)-Coniferyl alcohol, syringenin, dihydroconiferyl alcohol, C-veratroylglycol, 2,3-Dihydroxy-1-(4-hydroxy-3,5-dimethoxyphenyl)-1-propanone, 3-Hydroxy-1-(4-hydroxy-3,5-dimethoxyphenyl)propan-1-one, 3′,4′,5′-Trihydroxyacetophenone, 4-Acetylcatechol, 2,4,5-Trihydroxyacetophenone, 1-(2,3,4-trihydroxy-5-methylphenyl)-ethanone, 2-Hydroxy-3′,4′-dihydroxyacetophenone, 4-(dimethoxymethyl)-pyrocatechol, Catechaldehyde 3,4-Dihydroxy-2-methylbenzaldehyde, catechol, catechin, epicatechin, fumaric acid, oxalic acid, pyruvic acid, quinic acid, tartaric acid, skimic acid, gluconic acid, lactic acid, acetic acid, sarcosine, glycine, β-amino-isobutyric acid, leucine, allo-isoleucine, isoleucine, arginine, anserine, 3-methyl-histidine, tyrosine, hydroxyl proline, aspartic acid, serine, lysine, threonine, methionine, cysteic acid, niacin, riboflavin, thiamin, panthothenic acid, choline, vitamin B6, absicissic acid, phaseic acid, auxine, cytokinine, triacontanol; and gibberelline.

According to another embodiment of the present invention, the pasteurized sap or sap concentrate according to the present invention may comprises from about 8.3×10⁻² and up to 1 part saccharose, from 0.001×10⁻³ and up to 7.8×10⁻³ part calcium, from 0.001×10⁻³ and up to 7.8×10⁻³ part potassium, from 0.001×10⁻³ and up to 3.9×10⁻³ part magnesium, from 0.001×10⁻³ and up to 3.9×10⁻³ part sodium, from 0.001×10⁻³ and up to 1.6×10⁻³ part vannilic acid, from 0.001×10⁻³ and up to 1.6×10⁻³ part syringic acid, from 0.001×10⁻³ and up to 1.6×10⁻³ part p-Coumaric acid, from 0.001×10⁻¹ and up to 1.0×10⁻¹ of malic acid, from 0.001×10⁻³ and up to 1.6×10⁻³ part succinic acid, from 0.001×10⁻³ and up to 7.5×10⁻³ part alanine, from 0.001×10⁻² and up to 1.6×10⁻² part caline, from 0.001×10⁻² and up to 1.24×10⁻² part proline, from 0.001×10⁻² and up to 2.4×10⁻² part asparagine; and from 0.001×10⁻² and up to 4.7×10⁻² part glutamine.

According to yet another embodiment of the present invention, the pasteurized sap or sap concentrate according to the present invention may further comprises from 0 and up to 1.6×10⁻³ part of a protein matter, from 0 and up to 1.5×10⁻¹ part of fructose from 0 and up to 1.5×10⁻¹ part of glucose, from 0 and up to 1.5×10⁻¹ part of an oligosaccharide, from 0 and up to 1.5×10⁻¹ part of a polysaccharide, from 0 and up to 1.6×10⁻³ part manganese, from 0 and up to 1.6×10⁻³ part phosphorus, from 0 and up to 7.8×10⁻⁵ part aluminum, from 0 and up to 1.6×10⁻³ part sulfur, from 0 and up to 1.6×10⁻³ part iron, from 0 and up to 1.6×10⁻³ part boron, from 0 and up to 1.6×10⁻⁴ part cadmium, from 0 and up to 1.6×10⁻⁴ part molybdenum, from 0 and up to 1.6×10⁻⁴ part selenium, from 0 and up to 1.6×10⁻⁴ part zinc, from 0 and up to 1.6×10⁻⁴ part copper, from 0 and up to 1.6×10⁻⁴ part cis-aconitate, from 0 and up to 1.6×10⁻³ part vanillin, from 0 and up to 1.6×10⁻³ part hydroxybenzoic acid, from 0 and up to 1.6×10⁻³ part syringaldehyde, from 0 and up to 1.6×10⁻³ part homovannilic acid, from 0 and up to 1.6×10⁻³ part protocatechuic acid, from 0 and up to 1.6×10⁻³ part coniferyl aldehyde, from 0 and up to 1.6×10⁻³ part coniferol, from 0 and up to 1.6×10⁻³ part lyoresinol, from 0 and up to 1.6×10⁻³ part isolariciresinol, from 0 and up to 1.6×10⁻³ part secoisolariciresinol, from 0 and up to 1.6×10⁻³ part dehydroconiferyl alcohol, from 0 and up to 1.6×10⁻³ part 5′-methoxy-dehydroconiferyl alcohol, from 0 and up to 1.6×10⁻³ part erythro-guaiacylglycerol-b-O-4′-coniferyl alcohol, from 0 and up to 1.6×10⁻³ part erythro-guaiacylglycerol-b-O-4′-dihydroconiferyl alcohol, from 0 and up to 1.6×10⁻³ part [3-[4-[(6-deoxy-α-L-mannopyranosyl)oxy]-3-methoxyphenyl]methyl]-5-(3,4-dimethoxyphenyl)dihydro-3-hydroxy-4-(hydroxymethyl)-2(3H)-furanone, from 0 and up to 1.6×10⁻³ part Scopoletin, from 0 and up to 1.6×10⁻³ part fraxetin, from 0 and up to 1.6×10⁻³ part isofraxidin, from 0 and up to 1.6×10⁻³ part gallic acid, from 0 and up to 1.6×10⁻³ part ginnalin A (acertannin), from 0 and up to 1.6×10⁻³ part ginnalin B, from 0 and up to 1.6×10⁻³ part ginnalin C, from 0 and up to 1.6×10⁻³ part methyl gallate trimethyl ether, from 0 and up to 1.6×10⁻³ part (E)-3,3′-dimethoxy-4,4′-dihydroxy stilbene, from 0 and up to 1.6×10⁻³ part ferulic acid, from 0 and up to 1.6×10⁻³ part (E)-coniferyl alcohol, from 0 and up to 1.6×10⁻³ part syringenin, from 0 and up to 1.6×10⁻³ part dihydroconiferyl alcohol, from 0 and up to 1.6×10⁻³ part C-veratroylglycol, from 0 and up to 1.6×10⁻³ part 2,3-Dihydroxy-1-(4-hydroxy-3,5-dimethoxyphenyl)-1-propanone, from 0 and up to 1.6×10⁻³ part 3-Hydroxy-1-(4-hydroxy-3,5-dimethoxyphenyl)propan-1-one, from 0 and up to 1.6×10⁻³ part 3′,4′,5′-Trihydroxyacetophenone, from 0 and up to 1.6×10⁻³ part 4-Acetylcatechol, from 0 and up to 1.6×10⁻³ part 2,4,5-Trihydroxyacetophenone, from 0 and up to 1.6×10⁻³ part 1-(2,3,4-trihydroxy-5-methylphenyl)-ethanone, from 0 and up to 1.6×10⁻³ part 2-Hydroxy-3′,4′-dihydroxyacetophenone, from 0 and up to 1.6×10⁻³ part 4-(dimethoxymethyl)-pyrocatechol, from 0 and up to 1.6×10⁻³ part catechaldehyde, from 0 and up to 1.6×10⁻³ part 3,4-Dihydroxy-2-methylbenzaldehyde, from 0 and up to 1.6×10⁻³ part Catechol, from 0 and up to 1.6×10⁻³ part catechin, from 0 and up to 1.6×10⁻³ part epicatechin, from 0 and up to 1.6×10⁻³ part fumaric acid, from 0 and up to 1.6×10⁻³ part oxalic acid, from 0 and up to 1.6×10⁻³ part pyruvic acid, from 0 and up to 1.6×10⁻³ part quinic acid, from 0 and up to 1.6×10⁻⁴ part tartaric acid, from 0 and up to 1.6×10⁻⁴ part skimic acid, from 0 and up to 1.6×10⁻³ part gluconic acid, from 0 and up to 1.6×10⁻³ part lactic acid, from 0 and up to 1.6×10⁻³ part acetic acid, from 0 and up to 1.6×10⁻³ part sarcosine, from 0 and up to 7.5×10⁻³ part glycine, from 0 and up to 1.6×10⁻³ part β-amino-isobutyric acid, from 0 and up to 1.3×10⁻³ part leucine, from 0 and up to 4.7×10⁻³ part allo-isoleucine, from 0 and up to 2.3×10⁻² part isoleucine, from 0 and up to 4.7×10⁻² part arginine, from 0 and up to 4.7×10⁻² part anserine, from 0 and up to 4.7×10⁻² part 3-methyl-histidine, from 0 and up to 4.7×10⁻² part tyrosine, from 0 and up to 4.7×10⁻² part hydroxyl proline, from 0 and up to 4.7×10⁻² part aspartic acid, from 0 and up to 4.7×10⁻² part serine, from 0 and up to 4.7×10⁻² part lysine, from 0 and up to 4.7×10⁻² part threonine, from 0 and up to 4.7×10⁻² part methionine, from 0 and up to 4.7×10⁻² part cysteic acid, from 0 and up to 1.0×10⁻³ part niacin, from 0 and up to 5.0×10⁻³ part riboflavin, from 0 and up to 1.0×10⁻³ part thiamin, from 0 and up to 1.0×10⁻³ part panthothenic acid, from 0 and up to 5.0×10⁻³ part choline, from 0 and up to 1.0×10⁻³ part vitamin B6, from 0 and up to 3.1×10⁻³ part absicissic acid, from 0 and up to 6.2×10⁻³ part phaseic acid, from 0 and up to 3.9×10⁻³ part Auxine, from 0 and up to 1.6×10⁻³ part cytokinine, from 0 and up to 1.6×10⁻³ part triacontanol; and from 0 and up to 1.6×10⁻⁴ part gibberelline.

According to another embodiment, there is provided a pasteurized or sterilized sap or sap concentrate which further comprises a preservative. According to yet another embodiment, there is provided a sap or sap concentrate which comprises a preservative. Preservatives are naturally occurring or synthetically produced substance that are added to products such as foods, pharmaceuticals, paints, biological samples, wood, etc. to prevent decomposition by microbial growth or by undesirable chemical changes, such as oxidation.

According to an embodiment, the preservative may be propanoic acid, sodium propanoate, calcium propanoate, potassium propanoate, sorbic acid, sodium sorbate, potassium sorbate, and calcium sorbate, benzoic acid, sodium benzoate, potassium benzoate, and calcium benzoate, a paraben, a sulfite, ethylene oxide, propylene oxide, sodium diacetate, dehydroacetic acid, sodium nitrite, caprylic acid, ethyl formate, disodium EDTA, methylchloroisothiazolinone and an antioxidant. The paraben may be butylparaben, ethylparaben, heptylparaben, methylparaben, propylparaben, or combinations thereof. The sulfite may be caustic sulphite caramel, sulphite ammonia caramel, sodium sulphite, sodium bisulphite, sodium metabisulphite, potassium metabisulphite, potassium sulphite, calcium sulphite, calcium hydrogen sulphite, potassium hydrogen sulphite, or combinations thereof. The antioxidant may be ascorbic acid, tocopherol, propyl gallate, tertiary butylhydroquinone, butylated hydroxyanisole, butylated hydroxytoluene, or combinations thereof.

According to another embodiment, there is provided a food or food ingredient comprising the pasteurized or sterilized sap or sap concentrate of the present invention. As used herein, an ingredient is a substance that forms part of a food mixture (in a general sense). For example, in cooking, recipes specify which ingredients are used to prepare a specific dish. According to an embodiment, the pasteurized or sterilized sap or sap concentrate of the present invention may be used in the preparation of food, as a majority constituent of such food (e.g. when such food is a beverage, a gelatin, or other food where the bulk of the food is a fluid) or as one of the ingredient, where it may be added to the recipe.

According to another embodiment, there is provided food prepared by sterilizing and/or pasteurizing a pasteurized or sterilized sap or sap concentrate of the present invention, or crude sap or sap concentrate supplemented or not with a preservative, which is also combined with at least one food ingredient.

The at least one food ingredient may be any known and acceptable food ingredients, which include for examples, but are not limited to fruits (dehydrated or not), vegetables (dehydrated or not), fruit mixtures, vegetable mixtures, fruit purees, vegetable purees, fruit powders, vegetable powders, fruit concentrates, vegetable concentrates, juices, alcools, liquids (e.g. water, milk, etc.) spices, flavoring agents, vitamins, amino acids, oils, fats, vinegars, dairy ingredients (milks, yogurts, cheeses, etc), bacterial cultures, probiotic cultures, egg derived ingredient (yolk, egg white, egg powder, etc), dietary fibers, and combinations thereof.

The food thus prepared may then be subjected to a sterilization and/or pasteurization treatment by at least one of the methods and techniques described above, such as for example, but not limited to, a heat sterilization treatment, a dry heat sterilization treatment, a tyndallisation treatment, an upperization treatment, a high pressure processing treatment, canning, a UV treatment, a gamma ray treatment, a X-ray treatment, a pulsed light sterilization treatment, a microwave sterilization treatment, a pulsed electric field sterilization, a pulsed magnetic field sterilization, an ozone sterilization treatment, a microfiltration, a pasteurization treatment, a High Temperature Short Time (HTST) treatment, a thermization treatment, and combinations thereof. According to another embodiment, the pasteurized or sterilized sap or sap concentrate of the present invention may also be used as a culture medium. The unique formulation of the pasteurized or sterilized sap or sap concentrate of the present invention, which contains carbohydrates, amino acids, salts, as well as other molecules, make it suitable for supporting the growth of microorganisms, cells and even plants.

As used herein, a culture medium is a liquid or solid (e.g. a gel) designed to support the growth of microorganisms, cells or small plants (e.g. like the moss Physcomitrella patens), as may be appropriate for the type of microorganisms, cells or small plants.

There are two major types of growth media: those used for cell culture, which use specific cell types derived from plants or animals, and microbiological culture, which are used for growing microorganisms, such as bacteria or yeast. The most common growth media for microorganisms are nutrient broths and agar plates; specialized media are sometimes required for microorganism and cell culture growth. Some organisms, termed fastidious organisms, require specialized environments due to complex nutritional requirements. Therefore, according to some embodiment, the pasteurized or sterilized sap or sap concentrate of the present invention may be modified (e.g. pH adjustment, salinity adjustments, or the likes) and/or supplemented (e.g. addition of carbon source (e.g. carbohydrates), nucleotides or nucleotide mixtures, amino acids or amino acid mixtures, source of nitrogen, vitamins, co-factors) in order to sustain the growth.

The present invention will be more readily understood by referring to the following examples which are given to illustrate the invention rather than to limit its scope.

### Example 1

### Pasteurization Process of Maple Sap

Here the pasteurization process is used in the production of maple syrup. Maple sap is collected in outdoors storage tanks. It is then pumped through a series of filters and a reverse osmosis unit. The outlet of the reverse osmosis unit (maple filtrate) enters an evaporator and it is concentrated to obtain maple syrup.

Pasteurization of Maple Sap

Maple sap contains approximately 95.-99% water and about 1-5% sucrose. In order to pasteurize it, maple sap is pumped from the collected maple sap through a pre-filter 12 (first step) and then a micro-filter 14 (second step), using either the existing pump of the facility or a pump 11 as shown in FIG. 2.

It is then heated in a heat pasteurization step (third step) in a heating tank 16 and finally sent either to a storage tank 18 or to a kettle 19. The pasteurization step includes a mild continuous heat treatment (about 63° C. for 15 to 30 minutes, preferably 20 minutes, or about 80° C. for about 10 minutes).

The filtered maple sap may undergo through a further step of reverse osmosis treatment prior to being sent to the heating tank 16. The filtrate is heated in the heating tank 16 and then finally sent either to a storage tank 18 or to a kettle 19.

The 3-step pasteurization process resulted in an endogenous microbial reduction of approximately 7 log and no endogenous microorganisms were detected after four months storage at 4° C. Physicochemical analysis showed that the developed process resulted in only minor changes in terms of product features including a slight decline in total solids and an increase in invert sugar. No changes were observed in the pH level, which remained stable between 6 and 7 during said storage. These minor changes do not affect the integrity of the product and its taste.

Pasteurization of Maple Concentrate

Maple concentrate contains approximately 92.-68% water and about 6-32% carbohydrate, mostly comprised of 6-32% sucrose. In order to pasteurize it, maple concentrate is pumped through a pre-filter 12 (first step) and then a micro-filter 14 (second step), using either the existing pump of the facility or a pump 11 as shown in FIG. 2.

It is then heated in a heat pasteurization step (third step) in a heating tank 16 and finally sent either to a storage tank 18 or to a kettle 19. The pasteurization step includes a mild continuous heat treatment (about 63° C. for 15 to 30 minutes, preferably 20 minutes, or about 80° C. for about 10 minutes).

### Example 2

### Pasteurization Apparatus

General Apparatus Specifications

The apparatus diagram is illustrated in FIG. 1.

Flow rate: variable (0-15 m³/h)

Maple sap flow rates vary during the production season (very low/low productivity at the begging and end of the season and high productivity in the middle of the season). Filtrate flow rates are approximately 4 times lower than maple sap flow rates.

Temperature rating: 0° C.-100° C.

Power supply available: 240 Vac

Utilities available: electricity, tap water

Material in contact with product: Stainless steel grade 304L (SS 304L) or better may be used.

Product contact stainless steel surface finish: 2B

Exterior stainless steel surface finish: brushed surface

Connections: tri-clamp connections are preferred. Threaded connections may also be accepted when tri-clamp connections are not readily available.

Equipment Specifications

Pre-filter 12, 5 microns: The pre-filter is used to remove large particles from maple sap, thus preventing frequent clogging of the micro-filter.

Cartridge filter: 5 micron rating; membrane material is food quality and chosen from nylon, nitrocellulose, cellulose acetate, coated cellulose acetate, hydrophobic polytetrafluoroethylene, hydrophilic polytetrafluoroethylene, supported hydrophobic polytetrafluoroethylene, polycarbonate, activated carbon. The cartridge filter may be any food grade filtration cartridge, such an ultrafiltration cartridge used in the filtration of milk or juices.

Housing: Provide vent and drain port with valve.

Performance: Rated pressure is 100 psig

Suggested manufacturer: Millipore or Pall

Micro-filter 14, 1 micron: The micro-filter will be used to remove micro-particles and micro-organisms from the maple sap.

Cartridge filter: a 1 micron rating; membrane material is food quality and selected from nylon, nitrocellulose, cellulose acetate, coated cellulose acetate, hydrophobic polytetrafluoroethylene, hydrophilic polytetrafluoroethylene, supported hydrophobic polytetrafluoroethylene, polycarbonate, activated carbon. The cartridge filter may be any food grade filtration cartridge, such a ultrafiltration cartridges used in the filtration of milk or juices.

Housing: Provide vent and drain port with valve.

Performance: Rated pressure is 100 psig.

Suggested manufacturer: Millipore or Pall.

Heating Tank 16: The heating tank 16 is used to heat the maple sap coming out of the micro-filtration unit, as well as the maple filtrate coming out of the reverse osmosis unit. The fluid enters the tank at approximately 4° C. (range: 0-10° C.) and will be heated either to about 63° C. for about 20 minutes or to about 80° C. for about 10 minutes. Electrical heating may be used. A 5° C./min temperature increase is suggested for industrial scale systems. For sugar house systems, a 0.5° C. increase in temperature may be suggested to enable lower energy cost treatments, at a lower temperature for a longer time (e.g. 63° C. for about 20 minutes). The heating tank may also be used to heat tap water to about 80° C. for cleaning purposes. Hot water may be circulated in the system for a given period of time (approximately 30 minutes) for cleaning the system.

Total tank volume: 10 000 Liters; working volume: 75% of total volume.

Type: Cylindrical tank.

Bottom head type: Conical.

Gasket/O-ring material: Teflon (or equivalent food grade quality, temperature resistant material).

With vent.

With manhole.

Electrical heating coil inside tank jacket.

Required heating capacity: 3 MW.

Connections:
TOP (7):
   1″ tri-clamp for maple sap inlet
   1″ tri-clamp for maple filtrate inlet
   In-clamp for vent
   tri-clamp for pressure indicator
   tri-clamp for agitator
   1″ bi-clamp (spare)
   2″ tri-clamp (spare)
BOTTOM (1):
   1″ tri-clamp for maple sap/maple filtrate outlet
SIDE (4),
   tri-clamp for level control switch
   tri-clamp for level sensor
   tri-clamp for temperature indicator
   tri-clamp for sanitary thermowell (thermostat)

Mixer: A mixer will be used to ensure adequate heat transfer in the tank (not for vigorous mixing purposes).

Manually adjustable rotational speed. Suggested manufacturer: Promix Mixing Equipment & Engg. Ltd™. Or Grey Lighting™

Pump 11: The maple sap is pumped from the maple sap storage tank through the pre-filter 12 using either the existing pump situated after the storage tank 18, or with a pump 11. The pump 11 may also be used to pump maple filtrate from the filtrate storage tank 18 to the heating tank 16 as well as to supply cleaning water/bleach to the skid.

Pump 17: The maple sap/maple filtrate is pumped from the heating tank 16 to a kettle 19 or a storage tank 18. The pump will also be used for cleaning purposes: bleach and/or rinsing water will be recirculated in the system.

Centrifugal pump

Variable speed controller

Self support directly on floor

Completely self-drainable

Intermittent use

Suggested manufacturer: TopLine or Tri-Clover

Piping Specifications

Tubing:

Size: 1″ID

Pressure rating: 100 psig

All installed piping may be identified with the flow direction.

Manual Diaphragm Valves or Manual Ball Valves: All the valves may be manual valves, either diaphragm valves or ball valves. T

Size: 1″

Diaphragm/Ball valve material: Teflon or equivalent

Seals: Teflon or equivalent

Pressure rating: 100 psig

Suggested manufacturer: Crane Supply or Georg Fischer or PMP

Hydrostatic Testing

Hydrostatic testing on all piping shall be carried out after installation, for the specified rating pressure with no leak during 4 hours. Supplier shall provide a hydrostatic testing report

Instruments Specifications

Pressure indicators are installed before and after each filter (12 and 14) (a total of 4 pressure indicators) in order to monitor pressure drop in the filters and ensure timely cartridge replacement/cleaning. A supplementary pressure indicator may be used to monitor the pressure in the heating tank 16.

Type: Sanitary Gauge

Range: 0-100 psi

Dial: 2.5- or more

Displayed units of measure: psi

Suggested manufacturer: Winters

Temperature Indicator:

The thermometer is used to monitor the temperature of the fluid in the heating tank 16.

Type: Sanitary thermowell, Bi-metallic Thermometer

Dial: 2.5″ or more

Range: 0-100° C.

Displayed units of measure: ° F./° C.

Suggested manufacturer: Winters

Thermostat: The maple sap maple filtrate is heated in the heating tank from approximately 4° C. to about 63° C. or 80° C. The liquid is either maintained for about 20 minutes at about 63° C. or for about 10 minutes at about 80° C. The temperature of the liquid is continuously monitored and the electric heating flux is automatically adjusted to maintain the liquid at the given temperature set point. Tap water may also be heated to about 80° C. and circulated in the system for cleaning purposes. Electrical heating may be automatically adjusted to provide a 5° C./min liquid temperature increase (i.e. the suggested temperature increase rate).

Type: Rod thermostat for vessels, with sanitary immersion well

Temperature set point: 50-80° C.

Suggested manufacturer: Honeywell™

Flow Meter A: The flow meter is installed for information purposes after the distribution pump 11 or 17 (maple sap or maple filtrate heating tank outlet).

Type: Electromagnetic Flow meter.

The flow meter must be able to provide reliable flow rate measurement for values as low as 50 L/h and as high as 22 000 L/h. It should also be suitable for low conductivity fluids such as maple filtrate (obtained through reverse osmosis).

Displayed units of measure: LPM and/or GPM

Suggested manufacturer: Endress™+Hauser™

Flow Meter B: The flow meter will be installed for information purposes before the heating tank 16, on the maple sap inlet line.

Type: Electromagnetic Flow meter

The flow meter must be able to provide reliable flow rate measurement for values as low as 200 L/h and as high as 22 000 L/h.

Displayed units of measure: LPM and/or GPM

Suggested manufacturer: Endress™+Hauser™

Flow Meter C

The flow meter will be installed for information purposes before the healing tank 16, on the maple filtrate inlet line.

Type: Electromagnetic Flow meter

The flow meter must be able to provide reliable flow rate measurement for values as low as 50 L/h and as high as 3 000 L/h. It should also be suitable for low conductivity fluids such as maple filtrate (obtained through reverse osmosis).

Displayed units of measure: LPM and/or GPM

Suggested manufacturer: Endress™+Hauser™

Level Switch: A Level switch is installed in the heating tank to detect low-low level conditions.

Type: Tuning Fork Sensor

With audible alarm buzzer (initiated when low-low level conditions are detected)

Suggested manufacturer: Omega™

Level Sensor/Indicator: A level measuring device shall be installed in the heating tank to measure liquid level in the heating tank 16.

Type: Hydrostatic pressure Level sensor

With audible alarm buzzer (initiated when high level conditions are detected)

Suggested manufacturer: Endress™+Hauser™

### Example 3

### Predicted Electrical Specification of System—Sugar House System

For sugar house systems, increase in temperature from about 0.25° C./min to about 1° C./min is suggested to enable lower energy cost treatments, at a lower temperature, but for a longer time (e.g. 63° C. for about 20 minutes). Such systems have capacity of about 100 L to about 200 L.

TABLE 1

| | | | | | | Voltage | |
|---|---|---|---|---|---|---|---|
| Volume | | CP | Density | Time | Power | (V) | Amperage |
| (L) | ΔT | (J/kg) | (kg/L | (s) | (kW) | (3 Ph) | (A) |
| 100-200 | 0.25 | 4180 | 1 | 60 | 1.74 | 600 | 1.68 |
| 100-200 | 0.5 | 4180 | 1 | 60 | 3.48 | 600 | 3.36 |
| 100-200 | 1 | 4180 | 1 | 60 | 6.97 | 600 | 6.71 |

Systems as described in the present example are used in the context of a sugar house, employing 240 volts electricity for creating a temperature gradient as described above.

### Example 4

### Predicted Electrical Specification of System—Industrial System

TABLE 2

| | | | | | | Voltage | |
|---|---|---|---|---|---|---|---|
| Volume | | CP | Density | Time | Power | (V) | Amperage |
| (L) | ΔT | (J/kg) | (kg/L | (s) | (kW) | (3 Ph) | (A) |
| 10 000 | 0.25 | 4180 | 1 | 60 | 174.17 | 600 | 167.79 |
| 10 000 | 0.5 | 4180 | 1 | 60 | 348.33 | 600 | 335.58 |
| 10 000 | 1 | 4180 | 1 | 60 | 696.67 | 600 | 671.16 |

Electricity is not the preferred method of heating a system of about 10 000 L. Preferably, sources of heat such as propane gas or oil to heat a heat transfer fluid such as glycol or water are used.

### Example 5

### Filtration of Maple Sap

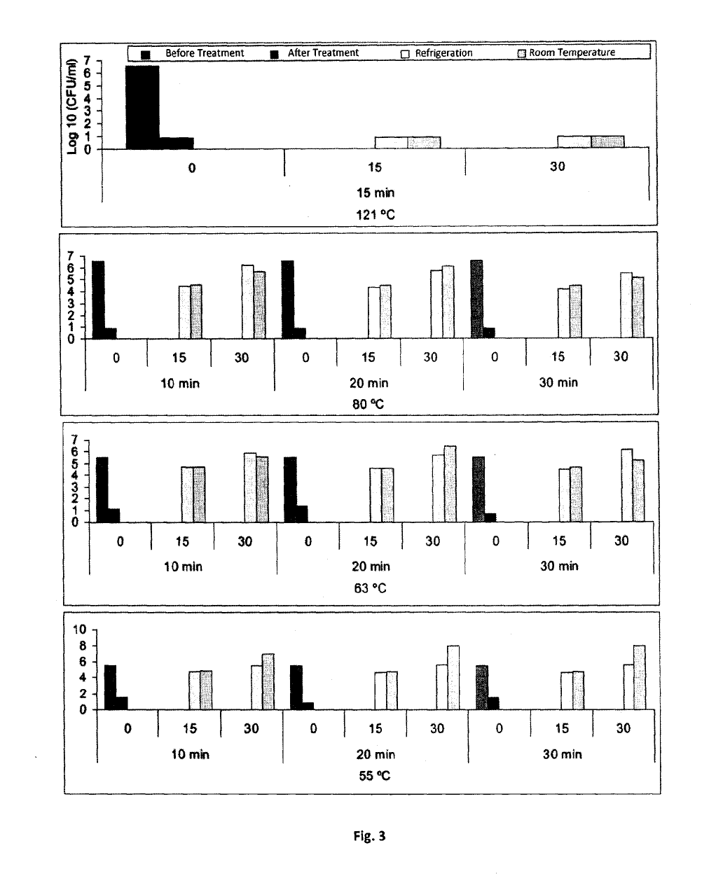

Now referring to FIG. 3, it is shown the total count of aerobic mesophiliac bacteria in maple sap following a heat treatment alone (15 or 30 minutes). The counts will vary according to the temperature that is used for the pasteurization step after a single treatment. At lower temperature, the bacterial count remains relatively high and is not sufficient for proper pasteurization.

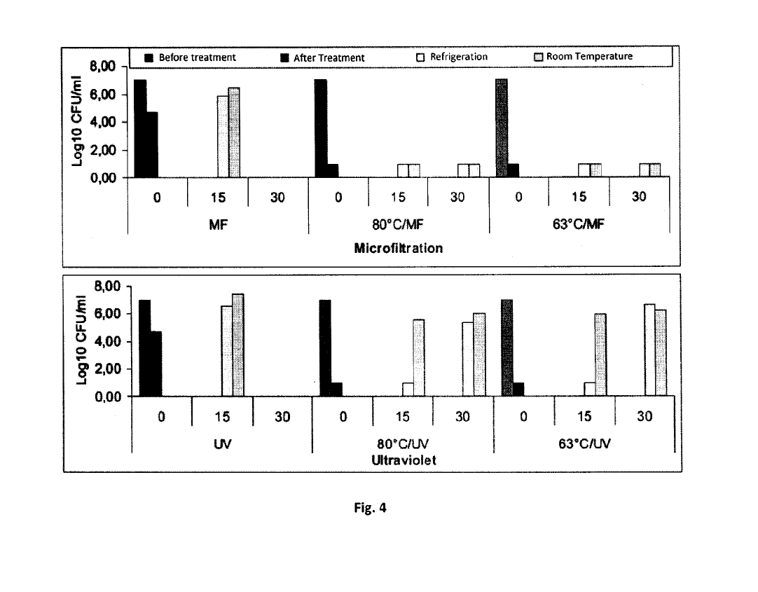

Now referring to FIG. 4, it is shown the total count of aerobic mesophiliac bacteria in maple sap following a heat treatment (15 or 30 minutes) that is preceded by either a treatment with ultraviolet light (UV), or preceded by a microfiltration (MF) step with a 0.8 μm filter. FIG. 4 shows that the combination of a thermal treatment with the microfiltration step is capable of reducing the microbial load to acceptable amounts. The use of either UV or MF with a 0.8 μm filter treatment alone is clearly unsatisfactory (FIG. 4), as is UV treatment combined with heat treatment. An average reduction of about 7 log is obtained by combining MF and heat treatment, and no microorganisms can be detected after 4 month of storage.

### Example 6

### Pasteurization of Maple Sap

Maple sap samples are collected from various sugar bush of the province of Quebec, Canada, between the months of February and April. The maple sap samples are prefiltered with a pre-filter with pore size of 5 μm and filtered with a filter having a pore size of 0.8 and/or 1 μm. The samples are then pasteurized either for 20 minutes at 63° C. and 10 minutes at 80° C. The physicochemical composition of the resulting pasteurized samples of maple sap is then determined.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A pretreatment apparatus for sterilization and/or pasteurization of sap or sap concentrate with a flow direction which comprises:
a pre-filter of pore size between about 1 μm to about 500 μm; and
a micro-filter of pore size between about 0.1 to about 1 μm;
wherein said micro-filter is connected to and after said pre-filter in the flow direction, said apparatus is for connection before a storage tank, a heating tank or a kettle to filter sap or sap concentrate collected prior to a sterilization and/or a pasteurization treatment.

2. The pretreatment apparatus of claim 1, which further comprises:
a secondary treatment apparatus connected after said micro-filter and for connection before a storage tank, a heating tank or a kettle, for further sterilization and/or pasteurization of said sap or sap concentrate.

3. The pretreatment apparatus of claim 2, wherein said secondary treatment apparatus is chosen from a UV treatment apparatus, a ultrasound apparatus, a CO₂ apparatus, a gamma ray treatment apparatus, a X-ray treatment apparatus, a pulsed light sterilization treatment apparatus, a microwave sterilization treatment apparatus, a pulsed electric field sterilization apparatus, a pulsed magnetic field sterilization apparatus, an ozone sterilization treatment apparatus, or combination thereof.

4. The pretreatment apparatus of claim 1, which further comprises:
a heating tank connected after said micro-filter and for connection before a kettle or a storage tank in the flow direction.

5. The pretreatment apparatus of any one of claims 1-4, wherein said pre-filter is made of nylon, cotton, a polypropylene fiber, polysulfone, steel or any other suitable material, or combinations thereof.

6. The pretreatment apparatus of any one of claims 1-4, wherein said pre-filter pore size is between about 1 μm to about 500 μm.

7. The pretreatment apparatus of any one of claims 1-4, wherein said micro-filter is made of nylon, cotton, a polypropylene fiber, polysulfone, steel or any other suitable material, or combinations thereof.

8. The pretreatment apparatus of any one of claims 1-4, wherein said micro-filter pore size is 1 μm.

9. The pretreatment apparatus of any one of claims 1-4, wherein said micro-filter pore size is 0.1 μm.

10. The pretreatment apparatus of anyone of claims 1-8, which further comprises:
a pump connected to said pre-filter, micro-filter, heating tank, storage tank or any other suitable storage mean.

11. The pretreatment apparatus of claim 10, wherein said pump has a flow rate between about 50 L/h to about 22 000 L/h.

12. The pretreatment apparatus of claim 11, wherein said pump has a flow rate between about 7500 L/h to about 22 000 L/h.

13. In a method of sterilization and/or pasteurization of sap or sap concentrate; the improvement characterized in the step of:
a) sterilization treatment of said sap or sap concentrate for a time sufficient to eliminate microbial life in said sap or sap concentrate with minimal taste alteration.

14. The method of claim 13, further comprising a step a′) prior to step a):
a′) pre-filtration of collected sap with a pre-filtration treatment.

15. The method of claim 14, wherein said pre-filtration treatment is chosen from a pre-filter of pore size between about 1 μm to about 500 μm, a centrifugation treatment, or combination thereof.

16. The method of claim 13, further comprising a step a″) prior to step a):
a″) micro-filtration of sap or sap concentrate with a micro-filter of pore size between about 0.1 μm to about 1 μm prior to said sterilization treatment of said sap or sap concentrate.

17. The method of claim 13, further comprising the steps a′) and b′) prior to step a)
a′) pre-filtration of collected sap with a pre-filter of pore size between about 1 μm to about 500 μm;
b′) micro-filtration of pre-filtered sap of step a′) with a micro-filter of pore size between about 0.1 μm to about 1 μm prior to said sterilization treatment of said sap or sap concentrate.

18. The method of any one of claims 16 to 17, wherein said micro-filter is a micro-filter of pore size between about 0.1 μm to about 0.2 μm.

19. The method of any one of claims 16 to 17, wherein said micro-filter is a micro-filter of pore size between about 0.2 μm to about 1 μm.

20. The method of any one of claims 16 to 17, wherein said micro-filter is a micro-filter of pore size of about 0.2 μm.

21. The method of any one of claims 13 to 18, wherein said sterilization treatment is at least one of a heat sterilization treatment, a dry heat sterilization treatment, a tyndallisation treatment, an upperization treatment, a high pressure processing treatment, canning, a ultrasound treatment, a CO₂ treatment, a UV treatment, a gamma ray treatment, a X-ray treatment, a pulsed light sterilization treatment, a microwave sterilization treatment, a pulsed electric field sterilization, a pulsed magnetic field sterilization, an ozone sterilization treatment, a microfiltration, and combinations thereof.

22. The method of claim 21, wherein said microfiltration is with a micro-filter of pore size between about 0.1 μm to about 0.2 μm.

23. The method of claim 21, wherein said microfiltration is with a micro-filter of pore size between about 0.2 μm to about 1 μm.

24. The method of claim 21, wherein said microfiltration is with a micro-filter of pore size of about 0.2 μm.

25. The method of claim 21, wherein said heat sterilization treatment is from about 100° C. to about 160° C. for about 1 seconds to about 60 seconds.

26. The method of claim 21, wherein said heat sterilization treatment is from about 130° C. to about 150° C. for about 2 seconds to about 8 seconds or from about 115° C. to about 137° C. for about 15 minutes to about 130 minutes.

27. The method of claim 21, wherein said heat sterilization treatment is from about 137° C. to about 140° C. for about 2 seconds to about 10 seconds.

28. The method of any one of claims 21 to 27, wherein said heat sterilization is performed by contacting said sap or sap concentrate with a heat exchanger.

29. The method of claim 28, wherein said heat exchanger is at least one of a plate heat exchanger, a shell and tube heat exchanger, a double tube heat exchanger, a triple tube heat exchanger, or combinations thereof.

30. The method of claim 14, wherein said sterilization treatment is a high pressure processing (HPP) treatment.

31. The method of claim 18, wherein said sterilization treatment is a high pressure processing (HPP) treatment.

32. The method of any one of claims 30 to 31, wherein said high pressure processing (HPP) treatment is from about 145 psi to about 145 000 psi for about 4 minutes to about 30 minutes.

33. The method of claim 32, wherein said high pressure processing (HPP) treatment is at about 87 000 psi for about 15 minutes.

34. The method of claim 32, wherein said high pressure processing (HPP) treatment is at about 87 000 psi for about 6 minutes.

35. The method of claim 32, wherein said high pressure processing (HPP) treatment is at about 87 000 psi for about 4 minutes.

36. The method of any one of claims 32 to 35, wherein said high pressure processing (HPP) treatment is performed for a volume of sap or sap concentrate of 1000 L or more.

37. The method of any one of claims 32 to 36, wherein said high pressure processing (HPP) treatment is performed by direct or indirect compression.

38. The method of claim 21, wherein said tyndallisation treatment is from about 70° C. to about 100° C., for about 30 mins to about 120 mins, for 3 consecutive days.

39. The method of claim 21, wherein said upperization treatment is from about 140° C. to about 150° C., for about 2 secs to about 3 seconds, followed by homogenization of said sap or sap concentrate.

40. The method of claim 21, wherein said UV treatment is from about 2000 μW s/cm² to about 9500 μW s/cm² of ultraviolet light for a time sufficient to effect sterilization.

41. The method of claim 21, wherein said UV treatment is from about 10 kGy to about 100 kGy.

42. The method of claim 21, wherein said UV treatment is from about 10 kGy or less.

43. The method of claim 21, wherein said UV treatment is from 5 kGy or less.

44. The method of claim 21, wherein said gamma ray treatment is from about 10 kGy to about 100 kGy.

45. The method of claim 21, wherein said gamma ray treatment is from about 1 kGy to about 15 kGy.

46. The method of claim 21, wherein said gamma ray treatment is from about 1 kGy to about 10 kGy.

47. The method of claim 21, wherein said X-ray treatment is from about 10 kGy to about 50 kGy.

48. The method of claim 21, wherein said X-ray treatment is from about 1 kGy to about 15 kGy.

49. The method of claim 21, wherein said X-ray treatment is from about 1 kGy to about 10 kGy.

50. The method of claim 21, wherein said pulsed light sterilization treatment is from about 0.25 J/cm² per pulse, for at least 2 pulses.

51. The method of claim 21, wherein said pulsed electric field sterilization is with an electric field from about 5 kV/cm to about 70 kV/cm, for 5 to 100 pulses of about 2 μsec to about 100 μsec.

52. The method of claim 21, wherein said pulsed magnetic field sterilization is with a pulsed magnetic field from about 5 Tesla to about 50 Tesla, having a pulse frequency of about 5 to about 500 kHz.

53. The method of claim 21, wherein said ozone treatment is from about 10 mg/L or less of ozone.

54. In a method of sterilization and/or pasteurization of sap or sap concentrate; the improvement characterized in the steps of:
a) pre-filtration of collected sap with a pre-filtration treatment;
b) micro-filtration of pre-filtered sap of step a) with a micro-filter of pore size between about 0.1 μm to about 1 μm prior to a pasteurization treatment of said sap or sap concentrate.

55. The method of claim 54, which further comprises a step c):
c) pasteurization treatment of said micro-filtered sap of step b) by heating from about 50° C. to at about 100° C. for a time sufficient to pasteurize.

56. The method of any one of claims 54 to 55, wherein said micro-filter is a micro-filter of pore size between about 0.2 μm to about 1 μm.

57. In a method of pasteurization of sap or sap concentrate; the improvement characterized in the steps of:
a) pasteurization treatment of said sap or sap concentrate by heating from about 50° C. to at about 100° C. for a time sufficient to pasteurize.

58. The method of any one of claims 55 and 57, wherein said time sufficient to pasteurize is from about 10 seconds to about 150 minutes.

59. The method of any one of claims 56-57, wherein said pasteurization treatment is a High Temperature Short Time (HTST) treatment.

60. The method of claim 59, wherein said High Temperature Short Time (HTST) treatment is from about 70° C. to 100° C. for about 15 seconds to about 30 seconds.

61. The method of claim 56, wherein said pasteurization treatment is a thermization treatment.

62. The method of claim 56, wherein said thermization treatment is from about 63° C. to about 65° C., for about 15 to 25 seconds.

63. The method of claim 44, wherein said pre-filtration treatment is chosen from a pre-filter of pore size between about 1 μm to about 500 μm, a centrifugation treatment, or combination thereof.

64. The method of any one of claims 13-63, wherein said sap or sap concentrate is produced by a plant chosen from an Acer tree, a birch, a pine, a hickory, a poplar, a coconut palm tree (Cocos nucifera), and an agave.

65. The method of claim 64, wherein said Acer tree is chosen from Acer nigrum, Acer lanum, Acer acuminatum, Acer albopurpurascens, Acer argutum, Acer barbinerve, Acer buergerianum, Acer caesium, Acer campbellii, Acer campestre, Acer capillipes, Acer cappadocicum, Acer carpinifolium, Acer caudatifolium, Acer caudatum, Acer cinnamomifolium, Acer circinatum, Acer cissifolium, Acer crassum, Acer crataegifolium, Acer davidii, Acer decandrum, Acer diabolicum, Acer distylum, Acer divergens, Acer erianthum, Acer erythranthum, Acer fabri, Acer garrettii, Acer glabrum, Acer grandidentatum, Acer griseum, Acer heldreichii, Acer henryi, Acer hyrcanum, Acer ibericum, Acer japonicum, Acer kungshanense, Acer kweilinense, Acer laevigatum, Acer laurinum, Acer lobelii, Acer lucidum, Acer macrophyllum, Acer mandshuricum, Acer maximowiczianum, Acer miaoshanicum, Acer micranthum, Acer miyabei, Acer mono, Acer mono×Acer truncatum, Acer monspessulanum, Acer negundo, Acer ningpoense, Acer nipponicum, Acer oblongum, Acer obtusifolium, Acer oliverianum, Acer opalus, Acer palmatum, Acer paxii, Acer pectinatum, Acer pensylvanicum, Acer pentaphyllum, Acer pentapomicum, Acer pictum, Acer pilosum, Acer platanoides, Acer poliophyllum, Acer pseudoplatanus, Acer pseudosieboldianum, Acer pubinerve, Acer pycnanthum, Acer rubrum, Acer rufinerve, Acer saccharinum, Acer saccharum, Acer sempervirens, Acer shirasawanum, Acer sieboldianum, Acer sinopurpurescens, Acer spicatum, Acer stachyophyllum, Acer sterculiaceum, Acer takesimense, Acer tataricum, Acer tegmentosum, Acer tenuifolium, Acer tetramerum, Acer trautvetteri, Acer triflorum, Acer truncatum, Acer tschonoskii, Acer turcomanicum, Acer ukurunduense, Acer velutinum, Acer wardii, Acer×peronai, and Acer×pseudoheldreichii.

66. A pasteurized or sterilized sap or sap concentrate prepared of the method of any one of claims 13-65.

67. The pasteurized or sterilized sap or sap concentrate of claim 66, wherein said pasteurized or sterilized sap or sap concentrate comprises saccharose, calcium, potassium, magnesium, sodium, vannilic acid, syringic acid, p-Coumaric acid, malic acid, succinic acid, Alanine, Valine, Proline; Asparagine, and Glutamine.

68. The pasteurized or sterilized sap or sap concentrate of claim 67, wherein said pasteurized or sterilized sap or sap concentrate further comprises at least one of a protein matter, fructose, glucose, an oligosaccharide, a polysaccharide, manganese, phosphorus, aluminum, sulfur, iron, boron, cadmium, molybdenum, selenium, zinc, copper, cis-aconitate, vanillin, hydroxybenzoic acid, syringaldehyde, homovannilic acid, protocatechuic acid, coniferyl aldehyde coniferol, lyoresinol, Isolariciresinol, secoisolariciresinol, dehydroconiferyl alcohol, 5′-methoxy-dehydroconiferyl alcohol, erythro-guaiacylglycerol-b-O-4′-coniferyl alcohol, erythro-guaiacylglycerol-b-O-4′-dihydroconiferyl alcohol, [3-[4-[(6-deoxy-α-L-mannopyranosyl)oxy]-3-methoxyphenyl]methyl]-5-(3,4-dimethoxyphenyl)dihydro-3-hydroxy-4-(hydroxymethyl)-2(3H)-furanone, scopoletin, fraxetin, isofraxidin, gallic acid, ginnalin A (acertannin), ginnalin B, ginnalin C, methyl gallate trimethyl ether, (E)-3,3′-dimethoxy-4,4′-dihydroxy stilbene, ferulic acid, (E)-Coniferyl alcohol, Syringenin, Dihydroconiferyl alcohol, C-veratroylglycol, 2,3-Dihydroxy-1-(4-hydroxy-3,5-dimethoxyphenyl)-1-propanone, 3-Hydroxy-1-(4-hydroxy-3,5-dimethoxyphenyl)propan-1-one, 3′,4′,5′-Trihydroxyacetophenone, 4-Acetylcatechol, 2,4,5-Trihydroxyacetophenone, 1-(2,3,4-trihydroxy-5-methylphenyl)-ethanone, 2-Hydroxy-3′,4′-dihydroxyacetophenone, 4-(dimethoxymethyl)-pyrocatechol, catechaldehyde 3,4-Dihydroxy-2-methylbenzaldehyde, catechol, catechin, epicatechin, fumaric acid, oxalic acid, pyruvic acid, quinic acid, tartaric acid, skimic acid, gluconic acid, lactic acid, acetic acid, sarcosine, glycine, β-amino-isobutyric acid, leucine, allo-isoleucine, isoleucine, arginine, anserine, 3-methyl-histidine, tyrosine, hydroxyl proline, aspartic acid, serine, lysine, threonine, methionine, cysteic acid, Niacin, riboflavin, thiamin, panthothenic acid, choline, vitamin B6, absicissic acid, phaseic acid, auxine, cytokinine, triacontanol, and gibberelline.

69. The pasteurized or sterilized sap or sap concentrate of any one of claims 67-68, wherein said pasteurized or sterilized sap or sap concentrate comprises:
from about 8.3×10⁻² and up to 1 part saccharose;
from 0.001×10⁻³ and up to 7.8×10⁻³ part calcium;
from 0.001×10⁻³ and up to 7.8×10⁻³ part potassium;
from 0.001×10⁻³ and up to 3.9×10⁻³ part magnesium;
from 0.001×10⁻³ and up to 3.9×10⁻³ part sodium;
from 0.001×10⁻³ and up to 1.6×10⁻³ part vannilic acid;
from 0.001×10⁻³ and up to 1.6×10⁻³ part syringic acid;
from 0.001×10⁻³ and up to 1.6×10⁻³ part p-Coumaric acid;
from 0.001×10⁻¹ and up to 1.0×10⁻¹ of malic acid;
from 0.001×10⁻³ and up to 1.6×10⁻³ part succinic acid;
from 0.001×10⁻³ and up to 7.5×10⁻³ part alanine;
from 0.001×10⁻² and up to 1.6×10⁻² part valine;
from 0.001×10⁻² and up to 1.24×10⁻² part proline;
from 0.001×10⁻² and up to 2.4×10⁻² part asparagine; and
from 0.001×10⁻² and up to 4.7×10⁻² part glutamine.

70. The pasteurized or sterilized sap or sap concentrate of any one of claims 67-69, wherein said pasteurized or sterilized sap or sap concentrate further comprises:
from 0 and up to 1.6×10⁻³ part of a protein matter;
from 0 and up to 1.5×10⁻¹ part of fructose;
from 0 and up to 1.5×10⁻¹ part of glucose;
from 0 and up to 1.5×10⁻¹ part of an oligosaccharide;
from 0 and up to 1.5×10⁻¹ part of a polysaccharide
from 0 and up to 1.6×10⁻³ part manganese;
from 0 and up to 1.6×10⁻³ part phosphorus;
from 0 and up to 7.8×10⁻⁵ part aluminum;
from 0 and up to 1.6×10⁻³ part sulfur;
from 0 and up to 1.6×10⁻³ part iron;
from 0 and up to 1.6×10⁻³ part boron;
from 0 and up to 1.6×10⁻⁴ part cadmium;
from 0 and up to 1.6×10⁻⁴ part molybdenum;
from 0 and up to 1.6×10⁻⁴ part selenium;
from 0 and up to 1.6×10⁻⁴ part zinc;
from 0 and up to 1.6×10⁻⁴ part copper;
from 0 and up to 1.6×10⁻⁴ part cis-aconitate
from 0 and up to 1.6×10⁻³ part vanillin;
from 0 and up to 1.6×10⁻³ part Hydroxybenzoic acid;
from 0 and up to 1.6×10⁻³ part syringaldehyde;
from 0 and up to 1.6×10⁻³ part homovannilic acid;
from 0 and up to 1.6×10⁻³ part protocatechuic acid;
from 0 and up to 1.6×10⁻³ part coniferyl aldehyde;
from 0 and up to 1.6×10⁻³ part coniferol;
from 0 and up to 1.6×10⁻³ part lyoresinol;
from 0 and up to 1.6×10⁻³ part Isolariciresinol;
from 0 and up to 1.6×10⁻³ part secoisolariciresinol;
from 0 and up to 1.6×10⁻³ part dehydroconiferyl alcohol;
from 0 and up to 1.6×10⁻³ part 5′-methoxy-dehydroconiferyl alcohol;
from 0 and up to 1.6×10⁻³ part erythro-guaiacylglycerol-b-O-4′-coniferyl alcohol;
from 0 and up to 1.6×10⁻³ part erythro-guaiacylglycerol-b-O-4′-dihydroconiferyl alcohol;
from 0 and up to 1.6×10⁻³ part [3-[4-[(6-deoxy-α-L-mannopyranosyl)oxy]-3-methoxyphenyl]methyl]-5-(3,4-dimethoxyphenyl)dihydro-3-hydroxy-4-(hydroxymethyl)-2(3H)-furanone;
from 0 and up to 1.6×10⁻³ part scopoletin;
from 0 and up to 1.6×10⁻³ part fraxetin;
from 0 and up to 1.6×10⁻³ part isofraxidin;
from 0 and up to 1.6×10⁻³ part gallic acid;
from 0 and up to 1.6×10⁻³ part ginnalin A (acertannin);
from 0 and up to 1.6×10⁻³ part ginnalin B;
from 0 and up to 1.6×10⁻³ part ginnalin C;
from 0 and up to 1.6×10⁻³ part methyl gallate trimethyl ether;
from 0 and up to 1.6×10⁻³ part (E)-3,3′-dimethoxy-4,4′-dihydroxy stilbene;
from 0 and up to 1.6×10⁻³ part ferulic acid;
from 0 and up to 1.6×10⁻³ part (E)-Coniferyl alcohol;
from 0 and up to 1.6×10⁻³ part syringenin;
from 0 and up to 1.6×10⁻³ part dihydroconiferyl alcohol;
from 0 and up to 1.6×10⁻³ part C-veratroylglycol;
from 0 and up to 1.6×10⁻³ part 2,3-Dihydroxy-1-(4-hydroxy-3,5-dimethoxyphenyl)-1-propanone;
from 0 and up to 1.6×10⁻³ part 3-Hydroxy-1-(4-hydroxy-3,5-dimethoxyphenyl)propan-1-one;
from 0 and up to 1.6×10⁻³ part 3′,4′,5′-Trihydroxyacetophenone;
from 0 and up to 1.6×10⁻³ part 4-Acetylcatechol;
from 0 and up to 1.6×10⁻³ part 2,4,5-Trihydroxyacetophenone;
from 0 and up to 1.6×10⁻³ part 1-(2,3,4-trihydroxy-5-methylphenyl)-ethanone;
from 0 and up to 1.6×10⁻³ part 2-Hydroxy-3′,4′-dihydroxyacetophenone;
from 0 and up to 1.6×10⁻³ part 4-(dimethoxymethyl)-pyrocatechol;
from 0 and up to 1.6×10⁻³ part Catechaldehyde;
from 0 and up to 1.6×10⁻³ part 3,4-Dihydroxy-2-methylbenzaldehyde;
from 0 and up to 1.6×10⁻³ part catechol;
from 0 and up to 1.6×10⁻³ part catechin;
from 0 and up to 1.6×10⁻³ part epicatechin;
from 0 and up to 1.6×10⁻³ part fumaric acid;
from 0 and up to 1.6×10⁻³ part oxalic acid;
from 0 and up to 1.6×10⁻³ part pyruvic acid;
from 0 and up to 1.6×10⁻³ part quinic acid;
from 0 and up to 1.6×10⁻⁴ part tartaric acid;
from 0 and up to 1.6×10⁻⁴ part skimic acid;
from 0 and up to 1.6×10⁻³ part gluconic acid;
from 0 and up to 1.6×10⁻³ part lactic acid;
from 0 and up to 1.6×10⁻³ part acetic acid;
from 0 and up to 1.6×10⁻³ part sarcosine;
from 0 and up to 7.5×10⁻³ part glycine;
from 0 and up to 1.6×10⁻³ part β-amino-isobutyric acid;
from 0 and up to 1.3×10⁻³ part leucine;
from 0 and up to 4.7×10⁻³ part allo-isoleucine;
from 0 and up to 2.3×10⁻² part isoleucine;
from 0 and up to 4.7×10⁻² part arginine;
from 0 and up to 4.7×10⁻² part anserine;
from 0 and up to 4.7×10⁻² part 3-methyl-histidine;
from 0 and up to 4.7×10⁻² part tyrosine
from 0 and up to 4.7×10⁻² part hydroxyl proline;
from 0 and up to 4.7×10⁻² part aspartic acid;
from 0 and up to 4.7×10⁻² part serine;
from 0 and up to 4.7×10⁻² part lysine;
from 0 and up to 4.7×10⁻² part threonine;
from 0 and up to 4.7×10⁻² part methionine;
from 0 and up to 4.7×10⁻² part cysteic acid
from 0 and up to 1.0×10⁻³ part niacin;
from 0 and up to 5.0×10⁻³ part riboflavin;
from 0 and up to 1.0×10⁻³ part thiamin;
from 0 and up to 1.0×10⁻³ part panthothenic acid;
from 0 and up to 5.0×10⁻³ part choline;
from 0 and up to 1.0×10⁻³ part vitamin B6;
from 0 and up to 3.1×10⁻³ part absicissic acid;
from 0 and up to 6.2×10⁻³ part phaseic acid;
from 0 and up to 3.9×10⁻³ part auxine;
from 0 and up to 1.6×10⁻³ part cytokinine;
from 0 and up to 1.6×10⁻³ part Triacontanol; and
from 0 and up to 1.6×10⁻⁴ part gibberelline.

71. The pasteurized or sterilized sap or sap concentrate of any one of claims 66 to 70, further comprising a preservative.

72. A sap or sap concentrate comprising a preservative.

73. The pasteurized or sterilized sap or sap concentrate of claim 71, or the sap or sap concentrate of claim 72, wherein said preservative is chosen from propanoic acid, sodium propanoate, calcium propanoate, potassium propanoate, sorbic acid, sodium sorbate, potassium sorbate, and calcium sorbate, benzoic acid, sodium benzoate, potassium benzoate, and calcium benzoate, a paraben, a sulfite, ethylene oxide, propylene oxide, sodium diacetate, dehydroacetic acid, sodium nitrite, caprylic acid, ethyl formate, disodium EDTA, methylchloroisothiazolinone, an antioxidant vitamin C, vitamin E, any suitable food preservatives and any combinations thereof.

74. The pasteurized or sterilized sap or sap concentrate of claim 73, wherein said paraben is chosen from butylparaben, ethylparaben, heptylparaben, methylparaben, propylparaben, or combinations thereof.

75. The pasteurized or sterilized sap or sap concentrate of claim 73, wherein said sulfite is chosen from caustic sulphite caramel, sulphite ammonia caramel, Sodium sulphite, Sodium bisulphite, Sodium metabisulphite, potassium metabisulphite, potassium sulphite, calcium sulphite, calcium hydrogen sulphite, potassium hydrogen sulphite, or combinations thereof.

76. The pasteurized or sterilized sap or sap concentrate of claim 73, wherein said antioxidant is chosen from ascorbic acid, tocopherol, propyl gallate, tertiary butylhydroquinone, butylated hydroxyanisole, butylated hydroxytoluene, or combinations thereof.

77. A food or food ingredient comprising the pasteurized or sterilized sap or sap concentrate of any one of claims 66 to 71 and 73 to 76, or the sap or sap concentrate of claim 72.

78. The food or food ingredient of claim 77, wherein said food is a beverage.

79. A food prepared by sterilizing and/or pasteurizing a pasteurized or sterilized sap or sap concentrate of any one of claims 66 to 71 and 73 to 76, or the sap or sap concentrate of claim 72, combined with at least one food ingredient.

80. A food prepared by sterilizing and/or pasteurizing a sap or sap concentrate combined with at least one food ingredient.

81. The food of any one of claims 79-80, wherein said sterilizing and/or pasteuring is at least one of a heat sterilization treatment, a dry heat sterilization treatment, a tyndallisation treatment, an upperization treatment, a high pressure processing treatment, canning, a UV treatment, a gamma ray treatment, a X-ray treatment, a pulsed light sterilization treatment, a microwave sterilization treatment, a pulsed electric field sterilization, a pulsed magnetic field sterilization, an ozone sterilization treatment, a microfiltration, a pasteurization treatment, a High Temperature Short Time (HTST) treatment, a thermization treatment, and combinations thereof.

82. The food of any one of claims 79 to 81, wherein said at least one food ingredient is chosen from a fruit, a vegetable, a fruit mixture, a vegetable mixture, a fruit puree, a vegetable puree, a fruit powder, a vegetable powder, a fruit concentrate, a vegetable concentrate, a juice, an alcool, a liquid, a spice, a flavoring agent, a vitamin, an amino acid, an oil, a fat, a vinegar, a dairy ingredient, a bacterial culture, a probiotic culture, a egg derived ingredient, a dietary fiber, any other suitable food ingredient, and combinations thereof.

83. A culture medium comprising a pasteurized or sterilized sap or sap concentrate of any one of claims 66 to 70.

84. The culture medium of claim 83, wherein said culture medium is a liquid culture medium.

85. The culture medium of claim 83, wherein said culture medium is a solid culture medium.

86. The culture medium of any one of claims 83 to 85, wherein said culture medium is a microorganism culture medium, a prokaryotic cell culture medium, a eukaryotic cell culture medium, or a plant culture medium.

87. A cosmetic composition comprising the pasteurized or sterilized sap or sap concentrate of any one of claims 66 to 71 and 73 to 76, or the sap or sap concentrate of claim 72 in association with at least one cosmetic ingredient.
